(19) United States
(12) Patent Application Publication
(10) Pub. No.: US 2022/0174562 A1
(43) Pub. Date: Jun. 2, 2022

(54) STORING AND RESTORING CONDITIONAL HANDOVER IN SUSPEND-RESUME

(71) Applicant: Telefonaktiebolaget LM Ericsson (publ), Stockholm (SE)

(72) Inventors: Icaro L. J. DA SILVA, SOLNA (SE); Patrik Rugeland, STOCKHOLM (SE)

(21) Appl. No.: 17/434,733

(22) PCT Filed: Mar. 13, 2020
(86) PCT No.: PCT/IB2020/052327

§ 371 Date: Aug. 28, 2021

Related U.S. Application Data
(60) Provisional application No. 62/819,026, filed on Mar. 15, 2019.

(51) Int. Cl. H04W 36/00; H04W 76/20; H04W 76/30; H04L 5/00

(52) U.S. Cl. CPC H04W 36/00837; H04W 36/0058; H04L 5/0053; H04W 76/30; H04W 76/20

(57) ABSTRACT

An apparatus, computer program and a method of operating a wireless device in a communication network is provided. The method includes receiving a conditional handover configuration from a source network node, wherein the handover configuration is associated with a candidate target cell. The method includes storing the conditional handover configuration. The method includes monitoring a triggering condition associated with the conditional handover configuration during a connected state. The method includes transitioning from the connected state to a sleep state while retaining the stored conditional handover configuration during the sleep state. The method includes suspending the monitoring of the triggering condition associated with the conditional handover configuration during the sleep state.

### TECHNICAL FIELD

The present disclosure relates generally to communications, and more particularly to communication methods and related devices and nodes supporting wireless communications.

### BACKGROUND

RRC Connection Resume in NR and eLTE

The RRC state model is updated in NR (and in eLTE, i.e. LTE connected to 5GC) and a new RRC_INACTIVE state is introduced in addition to the existing RRC_IDLE and RRC_CONNECTED states inherited from LTE. In RRC_INACTIVE, the UE context from the previous RRC connection is stored in the RAN and is re-used the next time an RRC connection is established. The UE context includes information such as the UE security configuration, configured radio bearers etc. By storing the UE context in the RAN one avoids the signaling required for security activation and bearer establishment which is normally required when transitioning from RRC_IDLE to RRC_CONNECTED. This improves latency and reduces the signaling overhead. FIG. 1A illustrates state transitions between RRC_CONNECTED, RRC_IDLE and RRC_INACTIVE in NR.

RRC_INACTIVE mode is realized by introducing two new procedures “RRC connection suspend” (also called RRC connection release with SuspendConfig) and “RRC connection resume”. The gNB suspends a connection and moves the UE from RRC_CONNECTED to RRC_INACTIVE by sending a RRC release message with suspend indication (or configuration) to the UE. This may happen for example after the UE has been inactive for a certain period which causes the gNB internal inactivity timer to expire. Both the UE and gNB stores the UE context and the associated identifier (referred to as I-RNTI). It has been recently updated that two identifiers will be configured in the suspend configuration, a long and short I-RNTI. The one to be used in resume depends on an indication from the network in system information of the cell the UE tries to resume in. The two I-RNTI identifiers were introduced to support scenarios when the UE is resuming in a cell which only gives the UE a small scheduling grant for the first UL message. For this purpose, also two different resume messages has been introduced namely RRCResumeRequest and RRCResumeRequest1. In this disclosure, an RRC resume request is used to refer to both messages.

FIG. 1B illustrates an RRCRelease with suspend indication message.

At the next transition to RRC_CONNECTED, the UE resumes the connection by sending a RRC resume request including the following information to the gNB which the UE attempts to resume the connection towards (note that it may be another cell/gNB compared to the cell/gNB where the connection was suspended):
The I-RNTI (either the long or short I-RNTI depending on the system information indication)
A security token (called resumeMAC-I in the specification) which is used to identify and verify the UE at RRC connection resume
An indication of the cause of the resume, e.g. mobile originated data.

The gNB which serves the cell in which the UE is resuming is sometimes referred to as the target gNB, while the gNB serving the cell in which the UE was suspended in is sometimes referred to as the source gNB. To resume the connection, the target gNB determines which gNB is the source gNB (considering the gNB part of the I-RNTI) and request that gNB to send the UE's context. In the request the target provides, among other things, the UE ID and security token received from the UE as well as the target cell Cell ID.

The source gNB then locates the UE context based on the I-RNTI and verifies the request based on the security token. If successful, the gNB forwards the UE context to the target gNB, which then responds to the UE with RRC resume to confirm the connection is being resumed. The RRC resume message may also contain configurations to reconfigure the radio bearers being resumed. Finally, the UE acknowledges the reception of the RRC re-establishment by sending RRC re-establishment complete.

Note that the described NR RRC resume procedure works in a similar way in LTE (even though in the state model the UE is considered in RRC_IDLE with a stored context) and eLTE (i.e. when LTE is connected to 5GC).

FIG. 1C illustrates message flows associated with an RRCResumeRequest message from a UE to a target gNB.

In NR and in eLTE (LTE connected to 5GC) the RRCResume message in response to an RRCResumeRequest is encrypted and integrity protected. That is done using new security keys, derived based on the stored AS security context. This new key derivation (sort of a key update) is done as part of the resume procedure, in particular as part of the transmission of the RRCResumeRequest (or RRCResumeRequest1).

It is not only the RRCResume message that may be sent in response to the RRCResumeRequest message. In NR and eLTE, after the UE sends an RRC Resume Request kind of message (e.g. RRCResumeRequest or RRCResumeRequest1) the UE may receive a message on SRB1 that should also be encrypted, and integrity protected, as described above:
RRCRelease with suspend configuration moving the UE to RRC_INACTIVE;
RRCRelease without suspend configuration moving the UE to RRC_IDLE;
RRCResume moving the UE to RRC_CONNECTED;

Other messages may also be transmitted, an RRCReject with wait timer or RRCSetup (fallback to RRC_IDLE) but on SRB0 (i.e. not encrypted or integrity protected). All these possible responses are shown as follows in the specifications:

FIGS. 1D to 1H illustrate various possible responses of a network to an RRCResumeRequest message. In particular, the network may respond with an RRCResume message (FIG. 1D), an RRCSetup message (FIG. 1E), an RRCRelease message (FIG. 1F), an RRCRelease with suspend configuration message (FIG. 1G) or an RRCReject message (FIG. 1H).

Mobility Robustness Work Item in Rel-16 for LTE and NR and Conditional HO

Two new work items for mobility enhancements in LTE and NR have started in 3GPP in release 16. The main objectives of the work items are to improve the robustness at handover and to decrease the interruption time at handover.

One problem related to robustness at handover is that the HO Command (RRCConnectionReconfiguration with mobilityControlInfo and RRCReconfiguration with a reconfigurationWithSync field) is normally sent when the radio conditions for the UE are already quite bad. That may lead to that the HO Command may not reach the UE in time if the message is segmented or there are retransmissions.

In LTE and NR, different solutions to increase mobility robustness have been discussed in the past. One solution discussed in NR is called “conditional handover” or “early handover command”. To avoid the undesired dependence on the serving radio link upon the time (and radio conditions) where the UE should execute the handover, the possibility to provide RRC signaling for the handover to the UE earlier should be provided. To achieve this, it should be possible to associate the HO command with a condition, for example, based on radio conditions possibly similar to the ones associated to an A3 event, where a given neighbour becomes X dB better than target. As soon as the condition is fulfilled, the UE executes the handover in accordance with the provided handover command.

Such a condition could, for example, be that the quality of the target cell or beam becomes X dB stronger than the serving cell (similar to an A3-like event may be configured to trigger measurement reports). The threshold Y used in a preceding measurement reporting event should then be chosen lower than the one in the handover execution condition. This allows the serving cell to prepare the handover upon reception of an early measurement report and to provide the RRCConnectionReconfiguration with mobilityControlInfo (LTE) or RRCReconfiguration with a reconfigurationWithSync (NR) at a time when the radio link between the source cell and the UE is still stable. The execution of the handover is done at a later point in time (and threshold) which is considered optimal for the handover execution.

FIG. 2 depicts an example with a single serving and target cell. In practice there may often be many cells or beams that the UE reported as possible candidates based on its preceding RRM measurements.

In RAN2 #104 in Spokane in November 2018, the following has been agreed concerning conditional handover for LTE:

Agreements

1. Support configuration of one or more candidate cells for conditional handover.

⇒FFS how many candidate cells (UE and network impacts should be clarified).

Based on the latest agreements, the network may configure conditional handover commands for several of those candidates. The RRCConnectionReconfiguration (or RRCReconfiguration, in NR) for each of those candidates may differ, for example, in terms of the HO execution condition (RS to measure and threshold to exceed), in terms of the RA preamble to be sent when a condition is met or the configuration itself to be used in a specific target candidate.

While the UE evaluates the condition, it should continue operating per its current RRC configuration, i.e., without applying the conditional HO command. When the UE determines that the condition is fulfilled, it disconnects from the serving cell, applies the conditional HO command and connects to the target cell. These steps are equivalent to the current, instantaneous handover execution.

Inter-Node Messages for Mobility Preparation

RRC Inter-Node Messages

In NR and LTE, two inter-node messages are typically used: HandoverPreparationInformation and HandoverCommand. When the source node decides to handover the UE, the source node provides the target node with some information in the HandoverPreparationInformation that enables the target node to prepare an RRCReconfiguration (provided in the HandoverCommand) be used in target upon handover execution. Definitions from TS 38.331 are shown below (but a similar procedure exists in TS 36.331):
HandoverPreparationInformation

This message is used to transfer the NR RRC information used by the target gNB during handover preparation, including UE capability information. Further details on the HandoverPreparationInformation message are in TS 38.331.

Xn Inter-Node Messages for Handover/DC-Setup

According to TS 38.420, there is a function called “Handover preparation function” defined as follows:

Handover preparation function: This function allows the exchange of information between source and target NG-RAN nodes in order to initiate the handover of a certain UE to the target.

An equivalent function exists for DC setup, called “S-NG-RAN-node Addition Preparation.” Another function that is relevant for the context of this disclosure is the “Handover canceling function” defined as follows:

Handover cancellation function: This function allows informing an already prepared target NG-RAN node that a prepared handover will not take place. It allows releasing the resources allocated during a preparation.

These functions are defined in detail in TS 38.423.

### SUMMARY

Conditional handover configurations include RRCReconfiguration(s) messages prepared by target candidate nodes for target candidate cells (or at least similar content as the ones provided in that message) and triggering conditions to be monitored in connected mode (for example, something like an Ax event configuration). When suspend functionality was designed, such a function did not exist. Hence, it is unclear what the UE should do with the conditional handover (CHO) related configurations received in RRC_CONNECTED upon going to RRC_INACTIVE. Consequently, it is also unclear what happens when the UE resumes.

According to some embodiments of inventive concepts, a method of operating a wireless device in a communication network is provided. The method includes receiving a conditional handover configuration from a source network node, wherein the handover configuration is associated with a candidate target cell. The method includes storing the conditional handover configuration. The method includes monitoring a triggering condition associated with the conditional handover configuration during a connected state. The method includes transitioning from the connected state to a sleep state while retaining the stored conditional handover configuration during the sleep state. The method includes suspending the monitoring of the triggering condition associated with the conditional handover configuration during the sleep state.

According to various embodiments of inventive concepts, a method of operating a wireless device in a communication network is provided. The method includes while in a sleep state, transmitting a resume request to a network node to initiate transition from the sleep state to a connected state. The method includes receiving a resume message from the network node, wherein the resume message from the network node contains a command for handling a conditional handover configuration that was stored by the wireless device before transitioning to the sleep state. The method includes transitioning from the sleep state to the connected state. The method includes restoring, modifying or releasing the conditional handover configuration in accordance with the command in the resume message.

Wireless devices and computer program codes are also provided to perform similar operations.

A potential advantage that may be attained is that there may be no ambiguity or mismatch between the UE and the network in terms of the UE Inactive AS Context, when it comes to the conditional handover configuration(s) that were received by the UE in RRC_CONNECTED. In other words, both UE and network may have a common understanding of which exact configurations are stored and restored upon suspend and resume, respectively.

In addition, if the network has configured the UE with CHO configurations in CONNECTED and assumes that the UE will store these configurations upon entering INACTIVE, the network does not need to cancel the CHOs requested in target candidates, since the UE will not trigger anyway CHO when it comes back to CONNECTED. That may not require network signaling, and, even better, if the UE comes back to the same cell, which is a very typical scenario, the source node would not need to request CHO again likely for the same target node candidates when the UE comes back to CONNECTED. In another alternative, these resources in target candidates are suspended with some signaling, being up to network implementation.

Another potential advantage is the fact that the UE does not delete CHO configurations in suspend, and if it comes back in the same area/cell, the network may configure the same CHO configuration using delta signaling e.g. in RRC Resume with less information carried over the air interface, which is a more efficient usage of radio resources. In one of the alternatives, in resume procedure, the target candidate may update the UE's configuration e.g. providing a new C-RNTI and/or new Contention-free RACH resources, etc.

According to various other embodiments of inventive concepts, a method of operating a radio access network, RAN, node in a communication network is provided. The method includes receiving a first request from a source network node to configure conditional handover for a wireless device. The method includes in response to the first request, transmitting the conditional handover configuration to the source network node and reserving resources for conditional handover of the wireless device. The method includes receiving a second request from the source network node to suspend the conditional handover configuration for the wireless device. The method includes in response to the second request, suspending the resources for conditional handover of the wireless device.

According to various other embodiments of inventive concepts, a method of operating a radio access network, RAN, node in a communication network is provided. The method includes responsive to receiving the first request, transmitting a command to a wireless device that is in a connected state and that has a stored conditional handover configuration associated with a target cell candidate to transition to a sleep state. The method includes storing the conditional handover configuration.

According to yet other various embodiment of inventive concepts, a method of operating a radio access network, RAN, node in a communication network is provided. The method includes receiving a resume request message from the wireless device that is in the sleep state. The method includes retrieving a context associated with the wireless device. The method includes determining, based on the context, that conditional handover is supported by the wireless device. The method includes determining to configure conditional handover at the wireless device for a target cell candidate with a condition related to a measurement event. The method includes determining that the wireless device has a stored conditional handover configuration for the target cell candidate. The message includes transmitting a resume message to the wireless device.

RAN nodes and computer programs are also provided to perform similar operations.

### BRIEF DESCRIPTION OF THE DRAWINGS

The accompanying drawings, which are included to provide a further understanding of the disclosure and are incorporated in and constitute a part of this application, illustrate certain non-limiting embodiments of inventive concepts. In the drawings:

FIG. 1A illustrates state transitions between RRC_CONNECTED, RRC_IDLE and RRC_INACTIVE in NR;

FIG. 1B illustrates an RRCRelease with suspend indication message;

FIG. 1C illustrates message flows associated with an RRCResumeRequest message from a UE to a target gNB;

FIGS. 1D to 1H illustrate various possible responses of a network to an RRCResumeRequest message;

FIG. 2 depicts an example of conditional handover with a single serving and target cell;

FIG. 3 is a flowchart that illustrates an approach for handling conditional handover upon suspend/resume of a UE;

FIG. 4 is a block diagram illustrating a mobile terminal UE according to some embodiments of inventive concepts;

FIG. 5 is a block diagram illustrating a radio access network RAN node (e.g., a base station eNB/gNB) according to some embodiments of inventive concepts;

FIG. 6 is a flow chart that illustrates suspension of a stored conditional handover configuration according to some embodiments of inventive concepts;

FIG. 7A is a flow chart illustrating operations of a wireless device according to some embodiments of inventive concepts;

FIGS. 7B and 7C are flow charts illustrating operations of network nodes according to some embodiments of inventive concepts;

FIG. 8 is a flow chart that illustrates resumption of a stored conditional handover configuration according to some embodiments of inventive concepts;

FIG. 9A to 9D are flow charts illustrating operations of a wireless device according to some embodiments of inventive concepts; and

FIGS. 10A and 10B are flow charts illustrating operations of network nodes according to some embodiments of inventive concepts.

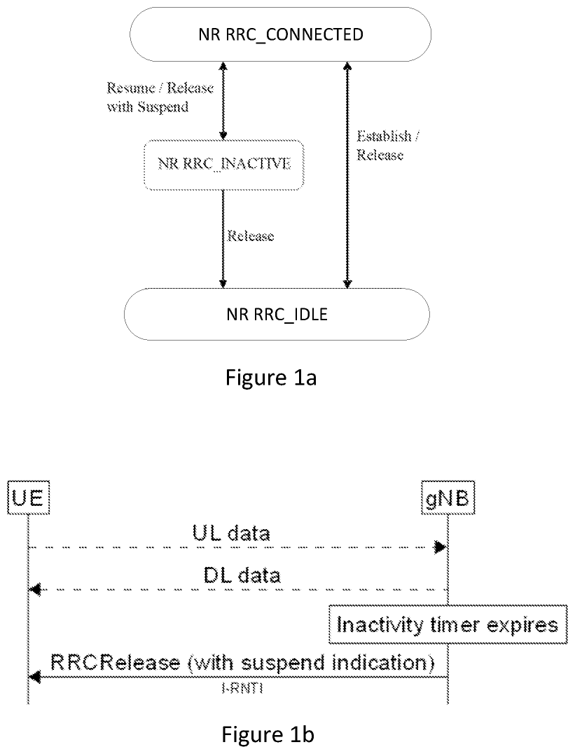

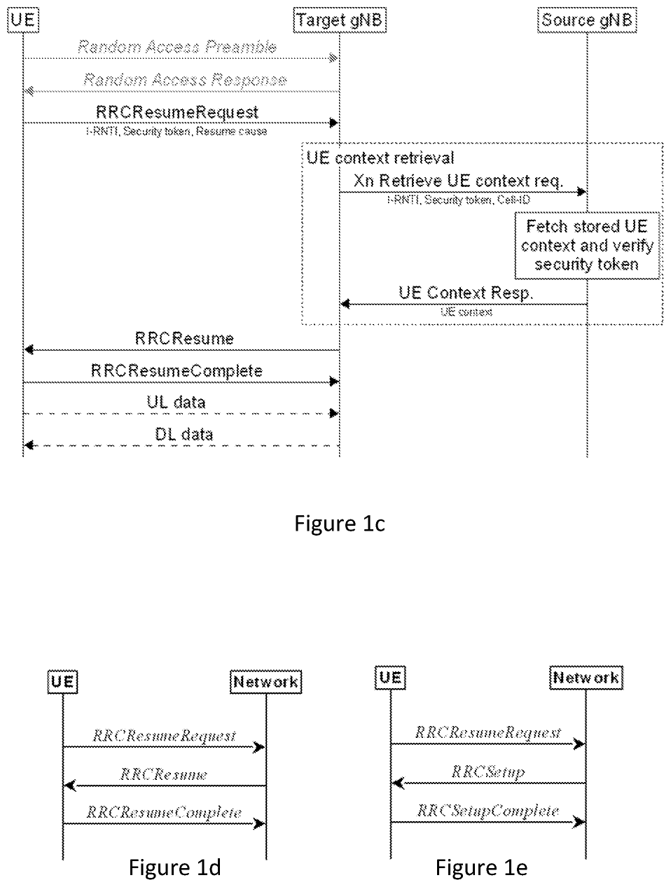

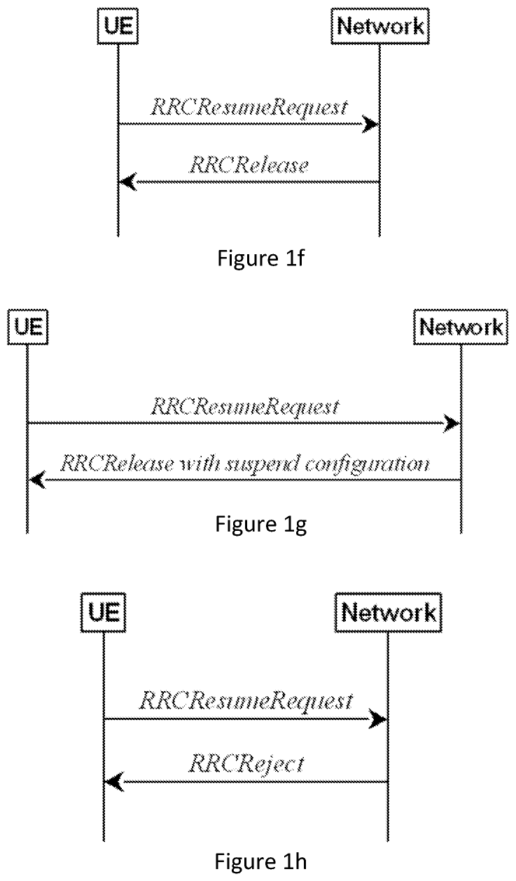

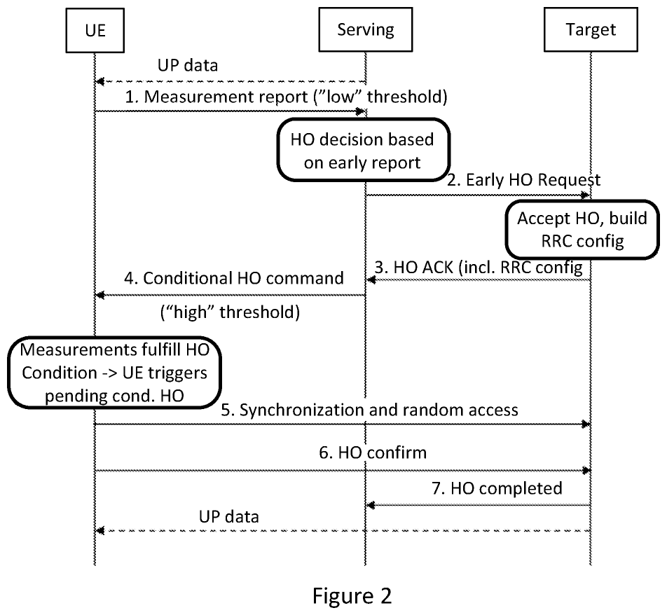

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

In current RRC specifications, the UE transitions from RRC_CONNECTED to RRC_INACTIVE upon the reception of an RRCRelease message containing a suspend configuration (suspendConfig).

According to that procedure, two types of parameters are stored. The first type of parameters are the ones provided in the RRCRelease message, and they are stored to be used while the UE is in inactive state or idle state, or upon the transition to connected again.

Another type of parameters that are stored upon the reception of the message are the ones the UE has received in RRC_CONNECTED and that are meant to be used when the UE resumes. Also, parameters the UE compute (such as security keys for encryption and integrity protection).

These procedures are shown below from TS 38.331 (where irrelevant steps have been omitted).

| 5.3.8.3 Reception of the RRCRelease by the UE | |
|---|---|
| The UE shall: | |
| <<<<Omitted irrelevant parts >>>> | |
| 1> | if the RRCRelease message includes the cellReselectionPriorities: |
| 2> | store the cell reselection priority information provided by the |

cellReselectionPriorities;

| | |
|---|---|
| 2> | if the t320 is included: |
| 3> | start timer T320, with the timer value set according to the value of t320; |
| 1> | else: |
| 2> | apply the cell reselection priority information broadcast in the system |

information;

| | |
|---|---|
| 1> | if deprioritisationReq is included: |
| 2> | start or restart timer T325 with the timer value set to the |

deprioritisationTimer signalled;

| | |
|---|---|
| 2> | store the deprioritisationReq until T325 expiry; |
| 1> | if the RRCRelease includes suspendConfig: |
| 2> | apply the received suspendConfig; |
| 2> | reset MAC and release the default MAC Cell Group configuration, if any; |
| 2> | re-establish RLC entities for SRB1; |
| 2> | if the RRCRelease message with suspendConfig was received in response |

to an RRCResumeRequest or an RRCResumeRequest1:

| | |
|---|---|
| 3> | stop the timer T319 if running; |
| 3> | in the stored UE Inactive AS context: |
| 4> | replace the K_{gNB} and K_{RRCint} keys with the current K_{gNB} and K_{RRCin} |

keys;

| | |
|---|---|
| 4> | replace the C-RNTI with the temporary C-RNTI in the cell the UE |

has received the RRCRelease message;

| | |
|---|---|
| 4> | replace the cellIdentity with the cellIdentity of the cell the UE has |

received the RRCRelease message;

| | |
|---|---|
| 4> | replace the physical cell identity with the physical cell identity of the |

cell the UE has received the RRCRelease message;

| | |
|---|---|
| 4> | replace the suspendConfig with the current suspendConfig; |
| 2> | else: |
| 3> | store in the UE Inactive AS Context the received suspendConfig, all |

current parameters configured with RRCReconfiguration or RRCResume, the
current K_{gNB} and K_{RRCint} keys, the ROHC state, the C-RNTI used in the source
PCell, the cellIdentity and the physical cell identity of the source PCell;

<<<<Omitted irrelevant parts >>>>

Conditional handover configurations include RRCReconfiguration(s) messages prepared by target candidate nodes for target candidate cells (or at least similar content as the ones provided in that message) and triggering conditions to be monitored in connected mode (for example, something like an Ax event configuration). When suspend functionality was designed, such a function did not exist. Hence, it is unclear what the UE should do with the conditional handover (CHO) related configurations received in RRC_CONNECTED upon going to RRC_INACTIVE. Consequently, it is also unclear what happens when the UE resumes.

Some approaches may address this problem by providing a method at a UE (user equipment, wireless terminal) in which the UE discards (i.e. deleting, removing, etc.) conditional handover configuration(s) upon transitioning from connected (e.g., RRC_CONNECTED) to a sleeping state (e.g., RRC_INACTIVE or RRC_IDLE) and releasing associated resources e.g. upon the reception of an RRCRelease message (or any other trigger for connected to sleep state transition).

The method also includes the UE performing a set of cleaning up actions related to conditional handover (CHO) procedures such as discarding state variables (e.g. counters, etc.), discarding related measurements (e.g. the ones the UE was monitoring for the triggering conditions), stopping the monitoring of conditional handover conditions, stopping timers associated to conditional handover procedures (such as validity resource timers, failure timers, etc.).

The method also includes the possibility to the UE to be configured with CHO configurations upon resume procedure. The UE could have been configured with CHO configurations in RRC Resume like message (e.g. RRCResume or RRCConnectionResume), in response to an RRC Resume Request like message. In the solution, these were full CHO configurations i.e. network knows that the UE does not have any stored CHO configurations (as these were deleted in the previous step, when the UE enters RRC INACTIVE.

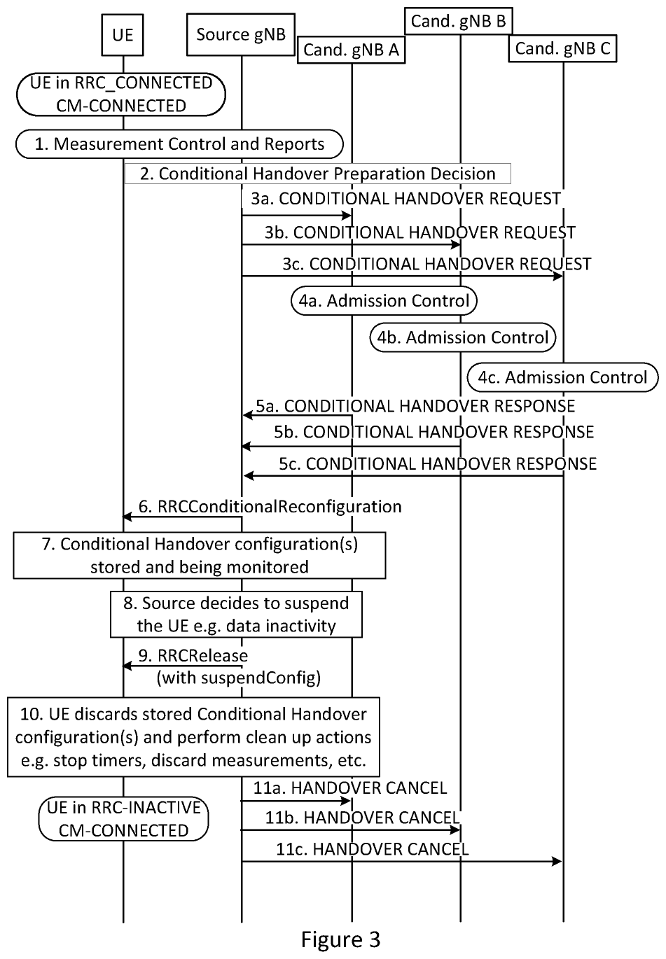

This approach is summarized in the signaling flow shown in FIG. 3. However, despite its simplicity, some aspects are not optimal in this approach.

The first sub-optimal aspect is that if the network has configured the UE with CHO configurations in CONNECTED and assumes that the UE will delete/discard these CHO configurations upon entering INACTIVE (i.e. upon reception of an RRC Release like message with a suspend configuration), the network needs to contact the target node candidates and cancel the CHOs that have been requested, since the UE would not trigger CHO anymore. That requires network signaling from source node to each target node with target cell candidates. And, even worse, if the UE comes back to the same cell (i.e. if the UE tries to resume in the same cell), which is a very typical scenario, the source node needs to request CHO again, likely to the same target node candidates when the UE comes back to CONNECTED. This is quite inefficient in terms of signaling on the network side.

Another suboptimal aspect is the fact that the UE deletes its stored CHO configurations when it is suspended to INACTIVE (or upon resume initiation). And, if the UE comes back in the same area/cell, the network may configure the same CHO configurations e.g. in RRC Resume. This represents a waste of resources over the radio interface as the UE had them stored before but delete them.

### SUMMARY OF EMBODIMENTS

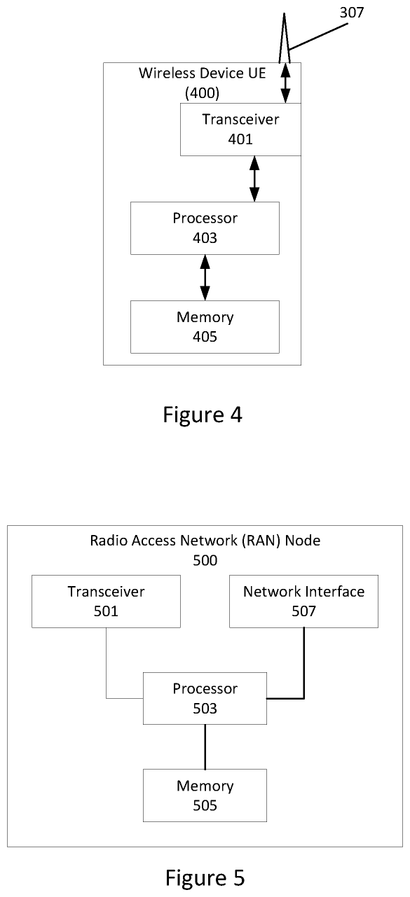

FIG. 4 is a block diagram illustrating elements of a wireless device UE 400 (also referred to as a mobile terminal, a mobile communication terminal, a wireless communication device, a wireless terminal, a wireless communication terminal, user equipment, UE, a user equipment node/terminal/device, etc.) configured to provide wireless communication according to embodiments of inventive concepts. As shown, wireless device UE may include an antenna 407, and transceiver circuitry 401 (also referred to as a transceiver) including a transmitter and a receiver configured to provide uplink and downlink radio communications with a base station(s) of a radio access network. Wireless device UE may also include processing circuitry 403 (also referred to as a processor) coupled to the transceiver circuitry, and memory circuitry 405 (also referred to as memory) coupled to the processing circuitry. The memory circuitry 405 may include computer readable program code that when executed by the processing circuitry 403 causes the processing circuitry to perform operations according to embodiments disclosed herein. According to other embodiments, processing circuitry 403 may be defined to include memory so that separate memory circuitry is not required. Wireless device UE may also include an interface (such as a user interface) coupled with processing circuitry 403, and/or wireless device UE may be incorporated in a vehicle.

As discussed herein, operations of wireless device UE may be performed by processing circuitry 403 and/or transceiver circuitry 401. For example, processing circuitry 403 may control transceiver circuitry 401 to transmit communications through transceiver circuitry 401 over a radio interface to a radio access network node (also referred to as a base station) and/or to receive communications through transceiver circuitry 401 from a RAN node over a radio interface. Moreover, modules may be stored in memory circuitry 405, and these modules may provide instructions so that when instructions of a module are executed by processing circuitry 403, processing circuitry 403 performs respective operations (e.g., operations discussed below with respect to Example Embodiments relating to wireless devices).

FIG. 5 is a block diagram illustrating elements of a radio access network RAN node 500 (also referred to as a network node, base station, eNodeB/eNB, gNodeB/gNB, etc.) of a Radio Access Network (RAN) configured to provide cellular communication according to embodiments of inventive concepts. As shown, the RAN node may include transceiver circuitry 501 (also referred to as a transceiver) including a transmitter and a receiver configured to provide uplink and downlink radio communications with mobile terminals. The RAN node may include network interface circuitry 507 (also referred to as a network interface) configured to provide communications with other nodes (e.g., with other base stations) of the RAN and/or core network CN. The network node may also include a processing circuitry 503 (also referred to as a processor) coupled to the transceiver circuitry, and a memory circuitry 505 (also referred to as memory) coupled to the processing circuitry. The memory circuitry 505 may include computer readable program code that when executed by the processing circuitry 503 causes the processing circuitry to perform operations according to embodiments disclosed herein. According to other embodiments, processing circuitry 503 may be defined to include memory so that a separate memory circuitry is not required.

As discussed herein, operations of the RAN node may be performed by processing circuitry 503, network interface 507, and/or transceiver 501. For example, processing circuitry 503 may control transceiver 501 to transmit downlink communications through transceiver 501 over a radio interface to one or more mobile terminals UEs and/or to receive uplink communications through transceiver 501 from one or more mobile terminals UEs over a radio interface. Similarly, processing circuitry 503 may control network interface 507 to transmit communications through network interface 507 to one or more other network nodes and/or to receive communications through network interface from one or more other network nodes. Moreover, modules may be stored in memory 505, and these modules may provide instructions so that when instructions of a module are executed by processing circuitry 503, processing circuitry 503 performs respective operations (e.g., operations discussed below with respect to Example Embodiments relating to RAN nodes).

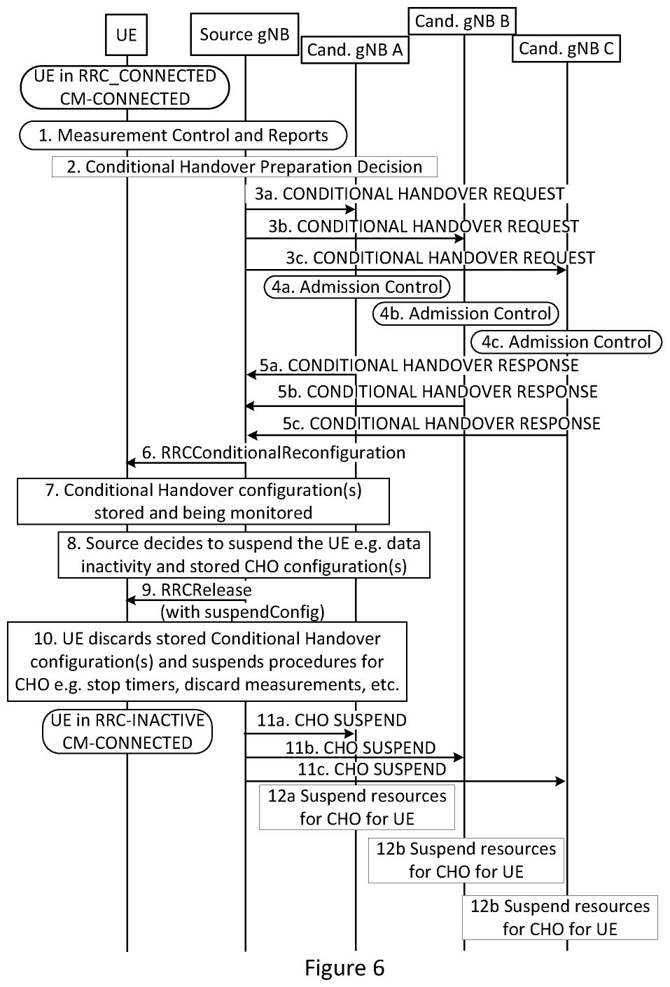

Some embodiments provide a method for handling conditional handover configurations when a UE enters a sleeping state (e.g. RRC_IDLE, RRC_INACTIVE or any other protocol state optimized for power savings), as illustrated in FIG. 6.

Referring to FIG. 6, a UE in RRC_CONNECTED state performs measurements (1) and reports the measurements to a source gNB to which the UE is connected. Based on the measurement reports, the source gNB makes a conditional handover decision (2), and then sends conditional handover requests (3a-3c) to candidate target gNBs A-C, each of which performs an admission control procedure (4a-4c) and sends a respective conditional handover response (5a-5c) in response. The source gNB then sends an RRCConditionalReconfiguration command (6) to the UE that contains a conditional handover configuration. In this example, the source gNB then determines (8) to suspend the UE (e.g. due to data inactivity) before initiating a handover to one of the target candidate gNBs. The source gNB stores the CHO configurations of the UE and sends an RRCRelease with suspendConfig to the UE (9). Upon receipt of this message, the UE stores the CHO configurations and suspends procedures related to CHO (10), such as stopping timers, discarding measurements, etc. The UE then transitions to RRC_INACTIVE state. The source gNB then sends CHO SUSPEND messages (11a-c) to each of the candidate target gNBs, which responsively suspend the resources associated with CHO for the UE (12a-c).

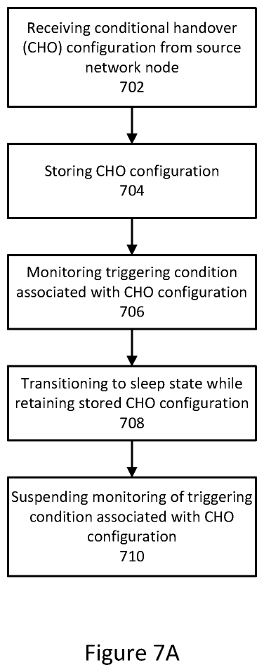

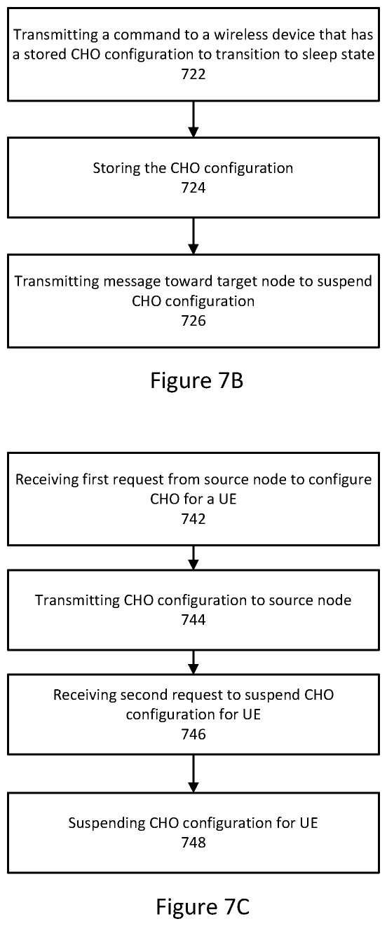

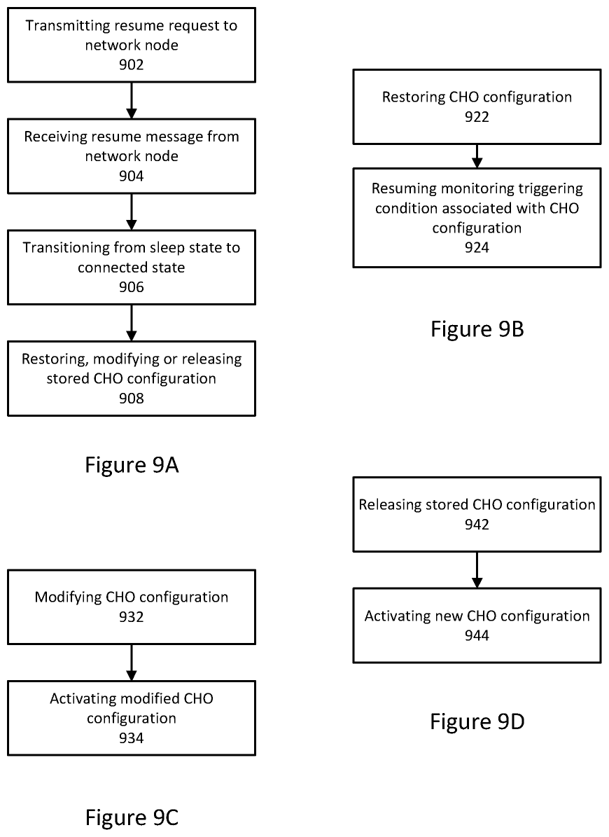

Operations of a wireless device 400 (such as a UE implemented using the structure of the block diagram of FIG. 4) are discussed with reference to the flow charts of FIGS. 7A, and 9A-9D according to some embodiments of inventive concepts. For example, modules may be stored in memory 405 of FIG. 4, and these modules may provide instructions so that when the instructions of a module are executed by respective wireless device processing circuitry 403, processing circuitry 403 performs respective operations of the flow charts.

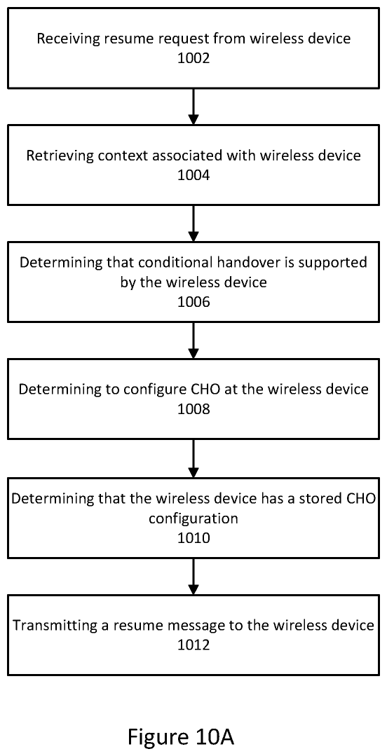

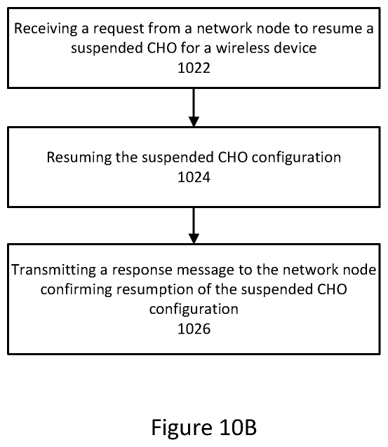

Operations of a RAN node 500 (implemented using the structure of FIG. 5) are discussed with reference to the flow charts of FIGS. 7B, 7C, 10A and 10B according to some embodiments of inventive concepts. For example, modules may be stored in memory 505 of FIG. 5, and these modules may provide instructions so that when the instructions of a module are executed by respective RAN node processing circuitry 503, processing circuitry 503 performs respective operations of the flow charts.

Referring to FIG. 7A, some embodiments provide a method at a UE (user equipment, wireless terminal) for handling conditional handover configurations when entering a sleeping state. The method incudes receiving (702) and storing (704) one or multiple conditional handover configuration(s) from a source network node where each of these configurations are associated to a target cell candidate e.g. while the UE is in RRC_CONNECTED or when the UE is entering CONNECTED. Each target cell candidate(s) can be associated to the target network node and/or a second network node.

In the connected state, the UE monitors (706) a triggering condition associated with the CHO configuration(s).

The UE may store conditional handover configuration(s) upon transitioning (708) from connected (e.g. RRC_CONNECTED) to a sleeping state (e.g. RRC_INACTIVE or RRC_IDLE) and not release associated resources e.g. upon the reception of an RRC Release (or similar) message (or any other trigger for connected to sleep state transition). In some embodiments, the UE may store the CHO configuration(s) as part of the UE AS Inactive context (possibly containing other information).

The UE may suspend (710) procedures associated to the CHO configurations, such as suspending measurements being performed for the monitoring of the CHO trigger conditions, stopping related timers, discarding related measurements (e.g. the ones the UE was monitoring for the triggering conditions), suspending the monitoring of conditional handover conditions, stopping timers associated to conditional handover procedures (such as validity resource timers, failure timers, etc.).

Referring to FIG. 7B, some embodiments provide a method at a source network node transitioning a UE from a connected state (e.g. RRC_CONNECTED) to a sleeping state (e.g. RRC_IDLE, RRC_INACTIVE or any other protocol state optimized for power savings). The method includes: transmitting (722) (or sending) a message to a UE that has stored conditional handover configuration(s) to suspend to inactive (e.g. an RRCRelease message with suspend configuration) or release to idle (e.g. an RRCRelease message without suspend configuration), where each of these conditional handover configurations are associated to a target cell candidate. The network node stores (724) conditional handover configuration(s) that were provided to that UE so that these specific CHO configurations are considered part of the stored UE Context (e.g. called UE Inactive AS context), or considered as part of the stored RRC configuration, upon transitioning from connected (e.g. RRC_CONNECTED) to a sleeping state (e.g. RRC_INACTIVE or RRC_IDLE), and transmits (726) a message to at least one target node candidate prepared with conditional handover configuration(s), possibly including an indication that the UE has been suspended or released, so that upon the reception of that information the target candidates may suspend conditional handover configuration(s), possibly freeing resources allocated for conditional handover.

In some embodiments, the UE may be configured with a timer that is started upon the reception of the CHO configurations. When the UE is suspended, the UE continues to run this timer and, if the timer expires while the UE is in inactive state, the UE deletes the CHO configurations. At the network side, in this variant, it means that the source node may not indicate the suspension of CHO to a target candidate (e.g. that has configured the timer to the UE) since this will anyway expire at some point.

Referring to FIG. 7C, some embodiments provide a method at a network node that is a target candidate for CHO for a given UE and neighbor node of a source network node that is transitioning a UE from a connected state (e.g. RRC_CONNECTED) to a sleeping state (e.g. RRC_IDLE, RRC_INACTIVE or any other protocol state optimized for power savings). The method includes receiving (742) a request from a source network node to configure CHO for a given UE e.g. receiving a CHO or HO REQUEST message over X2, Xn or any other inter-node interface, transmitting (744) in response a CHO configuration for a UE, e.g. transmitting a CHO or HO REQUEST ACK message over X2, Xn or any other inter-node interface. The target candidate network node may reserve resources for CHO for that UE, such as C-RNTI, contention-free RACH resources, etc.

The target candidate network node then receives (746) a request from a source network node to suspend previously configured CHO configurations for the UE. For example, the target candidate network node may receive a CHO or HO SUSPEND message over X2, Xn or any other inter-node interface. The target candidate network node then suspends (748) resources, such as the C-RNTI, contention-free RACH resources, etc., for CHO for that UE.

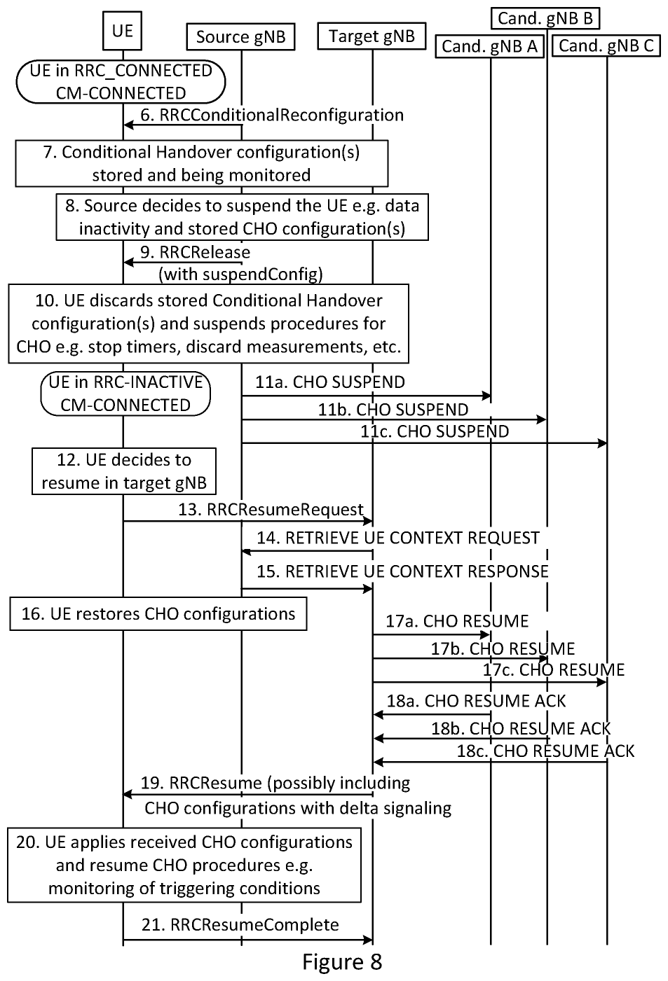

Some embodiments provide methods for resume conditional handover transitioning of a UE from a sleeping state to a connected state. For example, as shown in FIG. 8, a UE in RRC_CONNECTED state may receive an RRCConnectionReconfiguration message (6) from a source gNB with one or more CHO configuration(s). The UE then activates the CHO configuration(s) and actively monitors (7) trigger conditions associated with the CHO configuration(s). The source gNB may then determine to suspend the UE (8), and so sends an RRCRelease message (9) to the UE.

In response to the RRCRelease message, the UE stores (9) the CHO configuration(s) and suspends procedures associated with the CHO configuration(s). The UE then transitions to a sleep state, such as RRC_INACTIVE. The gNB sends CHO SUSPEND messages (11a-c) to each of the candidate target gNBs associated with the suspended CHO configuration.

Subsequently, the UE determines (12) to resume the connection to the network, and sends an RRCResumeRequest message (13) to the target gNB. Upon receipt of the RRCResumeRequest message, the target gNB retrieves (14, 15) the UE context for the UE from the source gNB (identified in the RRCResumeRequest message). Based on the CHO information in the UE context, the target gNB then sends CHO RESUME messages (17a-c) to the candidate target gNBs, which respond with CHO RESUME ACK messages (18a-c). The target gNB then sends a RRCResume message (19) to the UE, which may include new or modified CHO configuration information. The UE applies (20) the received CHO configuration information and sends a RRCResumeComplete message (21) back to the target gNB.

Referring to FIG. 9A, some embodiments provide a method at the UE (user equipment, wireless terminal) for resume conditional handover transitioning from a sleeping state (e.g. RRC_IDLE, RRC_INACTIVE or any other protocol state optimized for power savings) to a connected state (e.g. RRC_CONNECTED). The method includes transmitting (902) an RRC Resume Request (or similar) message to a target network node, and receiving (904) an RRC Resume like message, possibly containing conditional handover configuration(s) (e.g., delta-signaling) and restoring CHO configuration(s).

The UE transitions (906) from sleep state to connected state in response to the resume command, restores, modifies or releases (908) a stored CHO configuration in response to the release command.

Referring to FIG. 9B, if the RRC resume like message does not contain CHO configurations, the UE restores (922) the stored CHO configurations and resumes (924) the monitoring of CHO triggering conditions. In other words, the UE considers the stored CHO configurations as part of its current configurations and resume CHO procedures accordingly e.g. the monitoring of the CHO triggering conditions, measurements associated, etc.

Otherwise, referring to FIG. 9C, if the RRC resume like message contains new CHO configuration information, the UE modifies (932) the CHO configuration(s) by restoring the stored CHO configuration(s), applying the received CHO configuration information and activating (934) the modified CHO configuration by, for example, resuming the monitoring of CHO triggering conditions. The received configurations may remove (part of), add or modify CHO configurations having as basis the stored CHO configurations that have been restored.

Otherwise, referring to FIG. 9D, if the RRC resume like message contains an indication that the UE should release the CHO configurations, the UE releases (942) the stored CHO configurations and resumes the connection in accordance with the received RRC Resume like message by activating (944) the new CHO configuration(s), if present.

Referring to FIG. 10A, some embodiments provide a method at a target node for resuming conditional handover at the UE (user equipment, wireless terminal) transitioning from a sleeping state (e.g. RRC_IDLE, RRC_INACTIVE or any other protocol state optimized for power savings) to a connected state (e.g. RRC_CONNECTED). The method includes receiving (1002) an RRC Resume Request like message, retrieving (1004) the UE AS Context, if needed (e.g. UE Inactive AS Context, in case the UE identifier in Resume Request message indicates that the context is stored in another node), i.e. sending a Retrieve UE Context Request to the node storing the UE context, and receiving a Retrieve UE Context Response comprising the UE Inactive AS Context from the node storing the UE context, and determining (1006) that conditional handover is supported by the UE trying to resume, for example, based on UE capabilities indicating the support of conditional handover contained at the UE AS context, or based on the fact that the context contains stored CHO configurations.

The network node then decides (1008) to configure conditional handover to that UE for at least one target cell candidate cell-X with a condition related to measurement information, e.g., similar to an A3 event. The network node determines (1010) that the UE has a stored CHO configuration, and transmits (1012) a resume message to the UE.

The network node may initiate a conditional handover resume procedure for a target cell to another target node (e.g. by transmitting a conditional handover preparation or CHO RESUME message) and, receiving in response from at least one target node an acknowledgement of resumption of stored CHO configuration or, possibly an RRCReconfiguration for conditional handover, and transmitting to the UE an RRC Resume like message containing conditional handover configuration(s), possibly with delta signaling (i.e. considering that the UE has stored CHO configurations upon suspend, then restored during resume procedure and that is prepared to receive that delta configuration that may either remove, add or modify the restored CHO configuration).

Referring to FIG. 10B, some embodiments provide a method at a network node that is a target candidate for CHO for a given UE and neighbor node of a target network node that is transitioning a UE from a sleeping state (e.g. RRC_IDLE, RRC_INACTIVE or any other protocol state optimized for power savings), to a connected state (e.g. RRC_CONNECTED), the method includes receiving (1022) a request from the target network node to resume CHO for a given UE e.g. receiving a CHO or HO RESUME message over X2, Xn or any other inter-node interface, and resuming the suspended CHO configuration for the UE. The target candidate network node then transmits (1026) a CHO resume confirmation/acknowledgement for the UE confirming resumption of the suspended CHO configuration. For example, the target candidate network node may transmit a CHO or HO RESUME ACK message over X2, Xn or any other inter-node interface. The message may possibly contain modifications to CHO configurations, such as new RACH resources (e.g. contention-free random-access resources), a new C-RNTI, etc.).

Some embodiments described herein have potential advantages relative to other approaches. The first potential advantage is that there may be no ambiguity or mismatch between the UE and the network in terms of the UE Inactive AS Context, when it comes to the conditional handover configuration(s) that were received by the UE in RRC_CONNECTED. In other words, both UE and network may have a common understanding of which exact configurations are stored and restored upon suspend and resume, respectively.

In addition, if the network has configured the UE with CHO configurations in CONNECTED and assumes that the UE will store these configurations upon entering INACTIVE, the network does not need to cancel the CHOs requested in target candidates, since the UE will not trigger anyway CHO when it comes back to CONNECTED. That may not require network signaling, and, even better, if the UE comes back to the same cell, which is a very typical scenario, the source node would not need to request CHO again likely for the same target node candidates when the UE comes back to CONNECTED. In another alternative, these resources in target candidates are suspended with some signaling, being up to network implementation.

Another potential advantage is the fact that the UE does not delete CHO configurations in suspend, and if it comes back in the same area/cell, the network may configure the same CHO configuration using delta signaling e.g. in RRC Resume with less information carried over the air interface, which is a more efficient usage of radio resources. In one of the alternatives, in resume procedure, the target candidate may update the UE's configuration e.g. providing a new C-RNTI and/or new Contention-free RACH resources, etc.

According to some embodiments, a UE configured with a set of conditional RRCReconfiguration(s) shall execute a handover (or conditional handover, depending how the procedure is going to be called in NR RRC specifications) when the condition for the handover is fulfilled. In the context of this disclosure, what the disclosure refers to conditional handover related configuration(s) may be for a cell, list of cell(s), measurement object(s) or frequencies. In the case of the cell association, they may be for the same RAT or for a different RAT.

In the context of the method the “conditional handover related configuration(s)” for a cell comprises the following:

An RRCReconfiguration like message (or any message with equivalent content), possibly containing a reconfigurationWithSync using NR terminology (defined in 38.331 specifications) and prepared by target candidates. Or, using the E-UTRA terminology, an RRCConnectionReconfiguration with mobilityControlInfo (defined in 36.331 specifications);

Triggering condition(s) configuration e.g. something like A1-A6 or B1-B2 (inter-RAT events) triggering events (as defined in 38.331/36.331 in reportConfig) where instead of triggering a measurement report it would trigger a conditional handover; or

Other conditional handover controlling parameters e.g. timer defining the validity of target candidate resources, etc.

Agreements in 3GPP in RAN2 #105 point in that direction for the CHO configurations:

Agreements

1: The baseline operation for E-UTRAN Conditional HO procedure assumes HO command type of message contains HO triggering condition(s) and dedicated RRC configuration(s). UE accesses the prepared target when the relevant condition is met.

This disclosure uses the term handover or reconfiguration with sync with a similar meaning. Hence, a conditional handover may also be called a conditional reconfiguration with sync. In NR terminology, the handovers are typically called an RRCReconfiguration with a reconfigurationWithSync (field containing configuration necessary to execute a handover, like target information such as frequency, cell identifier, random access configuration, etc.). In E-UTRA terminology, the handovers are typically called an RRCConnectionReconfiguration with a mobilityControlInfo (field containing configuration necessary to execute a handover).

Most of the UE (and network) actions and network configurations are described as being performed in NR or E-UTRA. In other words, the configuration of a conditional HO received in NR for NR cells, UE is suspended in NR and UE resumes in NR. However, the method is also applicable when any of these steps occurs in different RATs, for example:
UE is configured with a conditional HO in E-UTRA (for candidate NR and E-UTRA cells), UE is suspended in E-UTRA, but UE resumes in E-UTRA;
UE is configured with a conditional HO in NR (for candidate NR and LTE cells), UE is suspended in NR, but UE resumes in E-UTRA;
UE is configured with a conditional HO in E-UTRA (for candidate NR and E-UTRA cells), UE is suspended in E-UTRA, but UE resumes in NR;
Or, in more general terms, UE is configured with a condition HO in RAT-1 for cells in RAT-1 or RAT-2, the UE is suspended in RAT-1, but the UE resumes in RAT-2.

The method is described in the context of conditional handover (or at least the described configurations to be handled in suspend/resume procedure is about CHO configuration(s)), which should not be interpreted as a limiting factor. The method may also be applicable for handovers triggered by the reception of an RRCReconfiguration message with a reconfigurationWithSync without any condition associated (or RRCConnectionReconfiguration with a mobilityControlInfo).

This disclosure uses the term “sleeping state” when referring to RRC_IDLE, RRC_INACTIVE or any other protocol state designed with procedures for battery savings and not so fast access, compared to connected state where the protocol actions are designed for fast access/data transmission.

Description of UE Suspend Procedure with CHO Configurations being Stored

Some embodiments provide a method at a UE (user equipment, wireless terminal) for handling of conditional handover configurations when entering a sleeping state (e.g. RRC_IDLE, RRC_INACTIVE or any other protocol state optimized for power savings), the method comprising the UE receiving and storing one or multiple conditional handover configuration(s) from a source network node where each of these configurations are associated to a target cell candidate e.g. while the UE is in RRC_CONNECTED.

One aspect of the method is storing conditional handover configuration(s) upon transitioning to a sleeping state (e.g. RRC_INACTIVE or RRC_IDLE).
One way to express the action of storing the conditional handover configuration(s) is to explicitly determine that CHO configurations are stored in sleeping state (e.g. RRC_INACTIVE or RRC_IDLE).
In one alternative, CHO configurations associated to all target cell candidates are stored;
In another alternative, CHO configurations associated to a subset of target cell candidates are stored; The subset may be indicated by the network e.g. in release/suspend procedure. In one implementation, the network may decide to keep stored configurations only for cells associated to the source node, to minimize inter-node signaling in the procedure (i.e. to suspend/resume CHO configurations).
In another alternative, only parts of each CHO configuration are stored. For example, if each CHO configuration comprises a trigger condition configuration and a dedicated RRC configuration (e.g. content of an RRCReconfiguration with reconfigurationWithSync) the UE only stores the trigger conditions. The thinking here is that this is something decided by source and not requiring coordination (i.e. inter-node signaling) with target candidates.
Another way is to say that all configurations provided in connected mode are stored, which may include CHO configurations, if they have been configured; In other words, if the UE has been configured in connected mode with CHO configurations, and the suspend procedure says “stores all parameters configured” that also includes CHO configurations (except if there is an exception for CHO configurations, which is not the case in the method proposed).
Another way is to explicitly express that conditional handover configurations are not discarded.
Another way is to assume that the conditional handover configuration(s) is part of the stored UE Inactive AS Context. And, once the UE enters RRC_CONNECTED from RRC_INACTIVE the UE may restore that from the AS Context.
Notice that in the specifications, we may either detail every parameter related to conditional handover and explicitly say that they are stored.

In some embodiments, the triggering point for storing these configurations is the transition from connected to sleeping state (e.g. RRC_CONNECTED to RRC_INACTIVE). Hence, the actions may be started upon the reception of an RRCRelease message containing a suspend configuration, field suspendConfig (which is an indication that the UE shall transition to RRC_INACTIVE instead of RRC_IDLE). This is not a limiting aspect. For example, if any other mechanism is introduced for the transition from RRC_CONNECTED to idle or inactive, the method and, in particular this aspect of storing the conditional handover configurations, is still applicable.

Another aspect of the method is the UE, upon entering a power saving state (e.g. reception of RRC Release like message as describe before), suspending CHO related procedure such as the monitoring of CHO triggering conditions and/or suspend measurements, according to the CHO configurations.

These actions may also comprise the UE performing a set of cleaning up or suspending actions related to conditional handover procedures such as discarding state variables (e.g. counters, etc.), discarding measurements, stopping the monitoring of conditional handover conditions, and stopping timers associated to conditional handover procedures (such as validity resource timers, failure timers, etc.).

One example of state variable related to conditional handover configuration(s) is a validity timer that may be configured to the UE to indicate for how long resources prepared by a target node candidate cell and/or node are valid, such as random-access channel (RACH) resources. Each target cell candidate prepares an RRCReconfiguration like message (possibly with a reconfigurationWithSync) and provides to the UE (via source node) with a triggering condition configuration (e.g. like an A3 event with threshold values, a measurement trigger quantity like RSRP, RSRQ or SINR, time to trigger, etc.) and, the timer is started upon the reception of that conditional handover configuration. Then, when the UE transitions from connected to sleeping state (e.g. RRC_INACTIVE) while these timers are running (e.g. one per target cell candidate or a common timer for all, to indicate validity of the whole configuration for all target candidates), according to the method there may be different alternatives such as:
The UE stops these validity resource timer(s), to avoid the UE to discard these configurations while the UE is in RRC_INACTIVE or even to bother about these configurations in RRC_INACTIVE or any other sleeping state; Then, upon resume the timer is re-started with the configured value;
The UE stops these validity resource timer(s), to avoid the UE to discard these configurations while the UE is in RRC_INACTIVE or even to bother about these configurations in RRC_INACTIVE or any other sleeping state; Then, upon resume the timer is re-started with the value that it was stopped before;
The UE does not stop these validity resource timer(s), i.e., when the timer expires the UE discards these CHO configurations associated while the UE is in RRC_INACTIVE; One advantage here is that the source node where the UE was suspended does not have to suspend CHO configuration in target candidates as these would be automatically deleted when the timer expires. Hence, keeping the timer running in inactive at the UE allows the flexibility to store these configurations in INACTIVE state and possibly resume them without too much network coordination during suspend/resume procedures; Then, upon resume the timer may be re-started depending on what the UE receives in RRC Resume like message;

The method also comprises the UE suspending the monitoring of the triggering conditions (e.g. A3 like event(s) associated to a cell or a set of cell(s) in a frequency) and suspending the required measurements associated to the triggering condition. These actions can either be explicitly modeled e.g. UE suspends measurements related to the monitoring of CHO triggering conditions or implicitly (i.e. if the UE enters a power saving state, like Inactive, the UE should not perform CHO related actions, which are implicitly considered suspended).

Below is an example of how the described action may be implemented in the NR RRC specifications TS 38.331, for the example where the triggering point to start the method is the reception of RRCRelease, where CHO actions are suspended, and CHO resource timers are stopped.

```
***************************************************************************
5.3.8.3 Reception of the RRCRelease by the UE
The UE shall:
  1>delay the following actions defined in this sub-clause 60 ms from the moment the
    RRCRelease message was received or optionally when lower layers indicate that the
    receipt of the RRCRelease message has been successfully acknowledged, whichever is
    earlier;
  1>stop timer T380, if running;
  1>stop timer T320, if running;
  1>stop timer T390, if running;
  1>if the security is not activated, perform the actions upon going to RRC_IDLE as specified
    in 5.3.11 with the release cause ‘other’ upon which the procedure ends;
  1>if the RRCRelease message includes redirectedCarrierInfo indicating redirection to eutra:
    2>if cnType is included:
      3>after the cell selection, indicate the available CN Type(s) and the received cnType to
        upper layers;
  NOTE: Handling the case if the E-UTRA cell selected after the redirection does not support
        the core network type specified by the cnType, is up to UE implementation.
  1>if the RRCRelease message includes the cellReselectionPriorities:
    2>store the cell reselection priority information provided by the cellReselectionPriorities;
    2>if the t320 is included:
      3>start timer T320, with the timer value set according to the value of t320;
  1>else:
    2>apply the cell reselection priority information broadcast in the system information;
  1>if deprioritisationReq is included:
    2>start or restart timer T325 with the timer value set to the deprioritisationTimer
      signalled;
    2>store the deprioritisationReq until T325 expiry;
  1>if the RRCRelease includes suspendConfig:
    2>apply the received suspendConfig;
    2>reset MAC and release the default MAC Cell Group configuration, if any;
    2>re-establish RLC entities for SRB1;
    2>if the RRCRelease message with suspendConfig was received in response to an
      RRCResumeRequest or an RRCResumeRequest1:
      3>stop the timer T319 if running;
      3>in the stored UE Inactive AS context:
        4>replace the K_{gNB} and K_{RRCint} keys with the current K_{gNB} and K_{RRCint} keys;
        4>replace the C-RNTI with the temporary C-RNTI in the cell the UE has received
          the RRCRelease message;
        4>replace the cellIdentity with the cellIdentity of the cell the UE has received the
          RRCRelease message;
        4>replace the physical cell identity with the physical cell identity of the cell the UE
          has received the RRCRelease message;
        4>replace the suspendConfig with the current suspendConfig;
    2>else:
      3>store in the UE Inactive AS Context the configured suspendConfig, the current K_{gNB}
        and K_{RRCint} keys, the ROHC state, the C-RNTI used in the source PCell, the
        cellIdentity and the physical cell identity of the source PCell, and all other parameters
        configured (e.g. including CHO configurations and state information concerning
        CHO such as the timer value for CHO reservation resources) except with
        ReconfigurationWithSync;
    2>suspend all SRB(s) and DRB(s), except SRB0;
    2>suspend all CHO procedures (e.g. monitoring of CHO triggering conditions);
    2>stop all instances of timer T3xx, if running (resource reservation timer for CHO
      configurations);
    2>indicate PDCP suspend to lower layers of all DRBs;
    2>if the t380 is included:
      3>start timer T380, with the timer value set to t380;
    2>if the RRCRelease message is including the waitTime:
      3>start timer T302 with the value set to the waitTime;
      3>inform the upper layer that access barring is applicable for all access categories
        except categories ‘0’ and ‘2’;
    2>indicate the suspension of the RRC connection to upper layers;
    2>enter RRC_INACTIVE and perform cell selection as specified in TS 38.304 [20];
  1>else
    2>perform the actions upon going to RRC_IDLE as specified in 5.3.11, with the release
      cause ‘other’.
*****************************************************************************
```

Description of Network Suspend Procedure

Some embodiments provide a method at a source network node transitioning a UE from a connected state (e.g. RRC_CONNECTED) to a sleeping state (e.g. RRC_IDLE, RRC_INACTIVE or any other protocol state optimized for power savings), the method comprising sending a message to suspend or release a UE (e.g. an RRCRelease message with or without suspend configuration) that has stored conditional handover configuration(s), where each of these conditional handover configurations are associated to a target cell candidate. A triggering condition configuration may be associated to multiple trigger criteria e.g. multiple trigger quantities, RS types, cell/beam measurements, etc.

The source node then stores conditional handover configuration(s) that were provided to that UE so that these specific configurations considered are part of the stored UE Inactive AS Context, upon transitioning from connected (e.g. RRC_CONNECTED) to a sleeping state (e.g. RRC_INACTIVE or RRC_IDLE).

Another action the source node may take is to inform at least one target node candidate prepared with conditional handover configuration(s), possibly including an indication that the UE has been suspended or released, so that upon the reception of that information the target candidates may store conditional handover configuration(s) and/or free or maintain resources allocated for conditional handover. This action is only taken if the UE is prepared with conditional handover configurations to cell(s) belonging to nodes other than the source node. In case the UE is configured with conditional handover configurations to cell(s) belonging to the source node, this action will be taken at the same node. This action may be implemented by triggering a CHO suspend procedure from source to a prepared target candidate, possibly including a cause value as the indication that the UE is being suspended.

Some embodiments provide a method at a network node that is a target candidate node for conditional handover, the method comprising suspending its prepared resources for incoming conditional handovers upon the reception of the indication from a source network node that the UE is transitioning to a sleeping state e.g. idle or inactive. That node may decide to down prioritize the allocation of these resources for new UEs (e.g. C-RNTI, contention-free RACH resources, etc.). But, if these resources need to be used while the UE is in inactive state, the target node candidate may do so. But then, when the UE tries to resume and the target candidate is contacted, the target candidate has the options to either confirm previously configured resources or modify the CHO configuration with updated resources (e.g. new C-RNTI, new RACH resources, etc.).

The UE and network steps are illustrated in FIG. 6.

Detailed Description of UE Resume Procedure

Some embodiments provide a method at the UE (user equipment, wireless terminal) for setting up conditional handover while it is transitioning from a sleeping state (e.g. RRC_IDLE, RRC_INACTIVE or any other protocol state optimized for power savings) to a connected state (e.g. RRC_CONNECTED), the method comprising the transmission of an RRC Resume Request like message and the reception an RRC Resume like message considering that the UE has restored its stored CHO configurations and possibly containing conditional handover configuration(s) to remove, add or modify CHO configurations that have been restored upon resume procedure.

Using NR RRC terminology, the RRC Resume like message may be an RRCResume message that includes fields/IEs with the similar fields/IEs used to configure a conditional handover. In LTE terminology this would be an RRCConnectionResume message.

The fields and IEs for conditional handover have not been specified in its details yet. Below we show one possible way to implement the signaling in the NR specifications. Herein the level of sophistication is to allow the UE to add or remove a whole CHO configuration, thanks to the CHO configuration identifier, without interfering with other conditions for CHO being monitored. With the following structure, it would also be possible to replace a whole trigger condition for the same RRCReconfiguration, thanks to the fact that within each configuration, trigger quantity and RRC configuration have both need code M i.e. if the CHO configuration is provided and the fields are absent, the stored ones should apply. However, if that is meant to be a modification procedure, at least one shall be present.

The following is an example of how some embodiments may be described in 3GPP TS 38.331 (including parameter definitions in the form of ASN.1 code and procedural description). In the example, a new IE called ConditionalReconfiguration is introduced:

```
ConditionalReconfiguration
The IE ConditionalReconfiguration message is the command to modify an RRC connection upon
the triggering of an associated condition. It may convey information for measurement
configuration, mobility control, radio resource configuration (including RBs, MAC main
configuration and physical channel configuration) including and security configuration.
ConditionalReconfiguration message
-- ASN1START
-- TAG-CONDITIONALRECONFIGURATION-START
ConditionalReconfiguration :: SEQUENCE {
-- Alternative relying on addModLists
  condReconfigurationToRemoveList CondReconfigurationToRemoveList OPTIONAL, --
Need N
  condReconfigurationToAddModList CondReconfigurationToAddModList OPTIONAL, --
Need N
CondReconfigurationToRemoveList ::= SEQUENCE (SIZE (1..maxNrofCondReconf)) OF
CondReconfigurationId
}
-- TAG-CONDITIONALRECONFIGURATION -STOP
-- ASN1STOP
- CondReconfigurationId
The IE CondReconfigurationId is used to identify a conditional reconfiguration, linking an
RRCReconfiguration with a trigger condition.
CondReconfigurationId information element
-- ASN1START
-- TAG-CONDRECONFIGURATIONID-START
CondReconfigurationId ::= INTEGER (1..maxNrofCondReconfigurationId)
-- TAG-CONDRECONFIGURATIONID-STOP
-- ASN1STOP
- CondReconfigurationToAddModList
The IE CondReconfigurationToAddModList concerns a list of conditional handover
configurations to add or modify.
CondReconfigurationToAddModList information element
-- ASN1START
-- TAG-CONDRECONFIGURATIONTOADDMODLIST-START
CondReconfigurationToAddModList ::= SEQUENCE (SIZE (1..maxNrofCondReconf))
OF CondReconfigurationAddMod
```

| | |
|---|---|
| CondReconfigurationAddMod::= | SEQUENCE { |
| condReconfigurationId | CondReconfigurationId, |
| rrc-ReconfigurationToApply | RRCReconfiguration OPTIONAL, -- Need M |
| measConfigCond | MeasIdToAddMod OPTIONAL, -- Need M |
| validityTimer | ENUMERATED {sec1, sec2, sec3, sec5, min10, min20, |

min30, min60, min120, min180, spare1} OPTIONAL, --Need M
...
}
-- TAG-CONDRECONFIGURATIONTOADDMODLIST-STOP
-- ASN1STOP
- MeasIdToAddModList
The IE MeasIdToAddModList concerns a list of measurement identities to add or modify, with
for each entry the measId, the associated measObjectId and the associated reportConfigId.
MeasIdToAddModList information element
-- ASN1START
-- TAG-MEASIDTOADDMODLIST-START

| | |
|---|---|
| MeasIdToAddModList ::= | SEQUENCE (SIZE (1..maxNrofMeasId)) OF |

MeasIdToAddMod

| | |
|---|---|
| MeasIdToAddMod ::= | SEQUENCE { |
| measId | MeasId, |
| measObjectId | MeasObjectId, |
| reportConfigId | ReportConfigId |

```
}
-- TAG-MEASIDTOADDMODLIST-STOP
-- ASN1STOP
- RRCResume
The RRCResume message is used to resume the suspended RRC connection.
  Signalling radio bearer: SRB1
  RLC-SAP: AM
  Logical channel: DCCH
  Direction: Network to UE
RRCResume message
-- ASN1START
-- TAG-RRCRESUME-START
```

| | |
|---|---|
| RRCResume ::= | SEQUENCE { |
| rrc-TransactionIdentifier | RRC-TransactionIdentifier, |
| criticalExtensions | CHOICE { |
| rrcResume | RRCResume-IEs, |
| criticalExtensionsFuture | SEQUENCE { } |

}
}

| RRCResume-IEs ::= | SEQUENCE { | |
|---|---|---|
| radioBearerConfig | RadioBearerConfig | OPTIONAL, -- Need M |

| | |
|---|---|
| masterCellGroup | OCTET STRING (CONTAINING CellGroupConfig) |

OPTIONAL, -- Need M

| | | |
|---|---|---|
| measConfig | MeasConfig | OPTIONAL, -- Need M |

| | | |
|---|---|---|
| fullConfig | ENUMERATED {true} | OPTIONAL, -- Need N |

| | | |
|---|---|---|
| lateNonCriticalExtension | OCTET STRING | OPTIONAL, |

| | |
|---|---|
| nonCriticalExtension | RRCResume-r16-IEs OPTIONAL |

}

| RRCResume-r16-IEs ::= | SEQUENCE { | |
|---|---|---|
| conditionalHandover | ConditionalReconfiguration | OPTIONAL, -- Need M |

}
-- TAG-RRCRESUME-STOP
-- ASN1STOP
RRCResume-IEs field descriptions
masterCellGroup
Configuration of the master cell group (NR Standalone):
radioBearerConfig
Configuration of Radio Bearers (DRBs, SRBs) including SDAP/PDCP.
conditionalHandover
Configuration of conditional handover including triggering conditions and dedicated RRC
configurations for target cell candidates.
Editor's Note: FFS Whether secondary group can be resumed.

In the context of this disclosure, even though we have shown measConfigCond field as a type MeasIdToAddMod, it should be seen as a generic field standing for a measurement configuration, which comprises at least a reportConfig-like configuration and a measurement object, indicating the frequency of the cell to be measured. The cell to be measured may either be indicated by the RRCReconfiguration, more precisely in the reconfigurationWithSync field prepared by a target candidate, or in the white cell list in reportConfig, or by a specific field indicating the cell identifier. The fundamental aspect here is that there is a trigger condition provided by the measConfigCond field, possibly based on measurements configured either here or previously configured. It could be possible that a measConfig field of MeasConfig IE is included in the RRCConditionalReconfiguration to provide the measurement objects (measObject(s)), reporting configurations (reportConfig or equivalent, to configure the triggering condition) and their respective identifiers, which may be then linked in the measConfigCond. The measConfig may also be provided in a separated message.

```
5.x.y Conditional handover configuration
5.x.y.1 General
The UE shall:
  1>if the received message RRCConditionalReconfiguration or RRCResume includes the
    condReconfigurationToRemoveList:
    2>perform the conditional handover configuration removal procedure as specified in
      5.x.y.2;
  1>if the received message RRCConditionalReconfiguration includes the
    condReconfigurationToAddModList:
    2>perform the conditional handover configuration addition/modification procedure as
      specified in 5.x.y.3;
5.x.y.2 Conditional handover configuration removal
The UE shall:
  1>for each condReconfigurationId included in the received
    condReconfigurationToRemoveList that is part of the current UE configuration in
    VarCondReconfig:
    2>stop the monitoring of the triggering condition associated to condReconfigurationId;
    2>stop the validity timer, if running;
    2>remove the entry with the matching condReconfigurationId from the
      condReconfigurationIdList within the VarCondReconfig;
        NOTE: The UE does not consider the message as erroneous if the
        condReconfigurationToRemoveList includes any condReconfigurationId value that is
        not part of the current UE configuration.
5.x.y.3 Conditional handover configuration addition/modification
The UE shall:
  1>for each condReconfigurationId included in the received
    condReconfigurationToAddModList:
    2>if an entry with the matching condReconfigurationId exists in the
      condReconfigurationIdList within the VarCondReconfig:
      3>stop the monitoring of the triggering condition associated to condReconfigurationId;
      3>stop the validity timer, if running;
      3>replace the entry with the value received for this condReconfigurationId and apply
        parameters according to their need codes;
      3>start the monitoring of the triggering condition associated to condReconfigurationId;
      3>start the validity timer, if configured, with received value;
    2>else:
      3>add a new entry for this condReconfigurationId within the VarCondReconfig;
      3>start the monitoring of the triggering condition associated to condReconfigurationId;
      3>start the validity timer, if configured, with received value;
```

The method also comprises the definition of a new UE variable to manage conditional handover configurations, e.g., called VarCondReconfig and defined as follows:

- VarCondReconfig
The UE variable VarCondReconfig includes the accumulated configuration of the conditional
handover configurations to be monitored by the UE.
VarCondReconfig UE variable
-- ASN1START
-- TAG-VARCONDRECONFIG-START

| | |
|---|---|
| VarMeasConfig ::= | SEQUENCE { |

-- conditional handover identities

| | |
|---|---|
| condReconfigurationIdList | CondReconfigurationToAddModList OPTIONAL, |

```
}
-- TAG-VARCONDRECONFIG-STOP
-- ASN1STOP
5.3.13.4 Reception of the RRCResume by the UE
The UE shall:
  1>stop timer T319;
  1>if the RRCResume includes the fullConfig:
    2>perform the full configuration procedure as specified in 5.3.5.11;
  1>else:
    2>restore the PDCP state and reset COUNT value for SRB2 and all DRBs;
    2>restore the cellGroupConfig from the stored UE AS context;
    2>restore the fields in conditionalHandover from the stored UE Inactive AS context;
    2>indicate to lower layers that stored UE AS context is used;
  1>discard the fullI-RNTI, shortI-RNTI and the stored UE AS context, except ran-
    NotificationAreaInfo;
  1>if the RRCResume includes the rnasterCellGroup:
    2>perform the cell group configuration for the received masterCellGroup according to
      5.3.5.5;
  Editor's Note: FFS Whether it is supported to configure secondaryCellGroup at Resume.
  1>if the RRCResume includes the radioBearerConfig:
    2>perform the radio bearer configuration according to 5.3.5.6;
  Editor's Note: FFS Whether there needs to be a second radioBearerConfig.
  1>resume SRB2 and all DRBs;
  1>if stored, discard the cell reselection priority information provided by the
    cellReselectionPriorities or inherited from another RAT;
  1>stop timer T320, if running;
  1>if the RRCResume message includes the measConfig:
    2>perform the measurement configuration procedure as specified in 5.5.2;
  1>resume measurements if suspended;
  1>if the RRCResume message includes the conditionalHandover:
    2>perform the CHO configuration procedure as specified in 5.x.y;
  1>resume the monitoring of CHO triggering conditions, if suspended;
  Editor's Note: FFS Whether there is a need to define UE actions related to access control
        timers (equivalent to T302, T303, T305, T306, T308 in LTE). For example,
        informing upper layers if a given timer is not running.
  1>enter RRC_CONNECTED;
  1>indicate to upper layers that the suspended RRC connection has been resumed;
  1>stop the cell re-selection procedure;
  1>consider the current cell to be the PCell;
  1>set the content of the of RRCResumeComplete message as follows:
    2>if the upper layer provides NAS PDU, set the dedicatedNAS-Message to include the
      information received from upper layers;
    2>if the upper layer provides a PLMN, set the selectedPLMN-Identity to PLMN selected
      by upper layers (TS 24.501 [23]) from the PLMN(s) included in the plmn-IdentityList in
      SIB1;
    2>if the masterCellGroup contains the reportUplinkTxDirectCurrent:
      3>include the uplinkTxDirectCurrentList;
  1>submit the RRCResumeComplete message to lower layers for transmission;
  1>the procedure ends.
**************************************************************************
```

In another embodiment related to this resume method, conditional handover may be configured during a reestablishment procedure, either by including conditional handover configuration(s) in a RRC Reestablishment like message (e.g. RRCReestablishment in NR or RRCConnectionReestablishment in LTE) or in an RRCReconfiguration message (the first after RRC Reestablishment like message) that may be multiplexed with the RRC Reestablishment like message. The actions upon reception are similar to the ones described for the resume case.

In another embodiment related to this resume method, conditional handover may be configured during a setup procedure, either by including conditional handover configuration(s) in a RRC Setup like message (e.g. RRCSetup in NR or RRCConnectionSetup in LTE) or in an RRCReconfiguration message (the first after RRC Reestablishment like message) that may be multiplexed with the RRC Reestablishment like message. The actions upon reception are similar to the ones described for the resume case.

Detailed Description of Network Resume Procedure

Some embodiments provide a method at a target network node for transitioning a UE from a sleeping state (e.g. RRC_IDLE, RRC_INACTIVE or any other protocol state optimized for power saving), the method comprises:

Receiving an RRC Resume Request like message;

Retrieve the UE AS Context, if needed (e.g. UE Inactive AS Context, in case the UE identifier in Resume Request message indicates that the context is stored in another node), i.e. send a Retrieve UE Context Request to the node storing the UE context, and receiving a Retrieve UE Context Response comprising the UE Inactive AS Context from the node storing the UE context;

Determine that conditional handover is supported by the UE trying to resume, for example, based on UE capabilities indicating the support of conditional handover contained at the UE AS context, or based on the fact that the context contains stored CHO configurations;

Decide to configure conditional handover to that UE for at least one target cell candidate cell-X with a condition related to measurement information, e.g., similar to an A3 event;

Possibly upon deciding that one or more configured target cell candidate cell-Y in the stored CHO configurations shall not be configured for the UE, initiate a release of conditional handover configurations in the candidate target cell to at least one target node (e.g. by transmitting a UE context release; CHO release; or handover cancellation message).

Possibly initiating a conditional handover resume procedure for a target cell to at least one target node (e.g. by transmitting a conditional handover preparation or CHO RESUME message) and, receiving in response from at least one target node an acknowledgement of resumption of stored CHO configuration or, possibly an RRCReconfiguration for conditional handover;

Transmitting to the UE an RRC Resume like message containing conditional handover configuration(s), possibly with delta signaling (i.e. considering that the UE has stored CHO configurations upon suspend, then restored during resume procedure and that is prepared to receive that delta configuration that may either remove, add or modify the restored CHO configuration).

Some embodiments provide methods at candidate target network nodes, configured with CHO configurations for a given UE, where the UE has entered a power saving state (e.g. RRC_INACTIVE or RRC_IDLE) with stored CHO configurations associated to the candidate target network node.

The Method Comprises:

Receiving a request from the target network node to resume CHO for a given UE e.g. receiving a CHO or HO RESUME message over X2, Xn or any other inter-node interface;

Possibly providing in response a CHO resume confirmation/acknowledgement for a UE e.g. transmitting a CHO or HO RESUME ACK message over X2, Xn or any other inter-node interface; That may possibly contain modifications to CHO configurations, such as new RACH resources (e.g. contention-free random-access resources), a new C-RNTI, etc.).

Example embodiments are discussed below.

Embodiment 1. A method of operating a wireless device in a communication network, the method comprising:

receiving (702) a conditional handover configuration from a source network node, wherein the handover configuration is associated with a candidate target cell;

storing (704) the conditional handover configuration;

monitoring (706) a triggering condition associated with the conditional handover configuration during a connected state;

transitioning (708) from the connected state to a sleep state while retaining the stored conditional handover configuration during the sleep state; and

suspending (710) the monitoring of the triggering condition associated with the conditional handover configuration during the sleep state.

Embodiment 2. The method of Embodiment 1, further comprising:

transitioning from the sleep state to the connected state;

restoring the conditional handover configuration; and

resuming monitoring the triggering condition associated with the conditional handover configuration.

Embodiment 3. The method of any previous Embodiment, wherein the sleep state comprises an RRC_IDLE state, an RRC_IDLE with suspended RRC connection state, or an RRC_INACTIVE state, and wherein the connected state comprises an RRC_CONNECTED state.
Embodiment 4. The method of any previous Embodiment, wherein the conditional handover configuration is received while the wireless device is in the connected state or is transitioning to the connected state.
Embodiment 5. The method of any previous Embodiment, further comprising:
retaining resources associated with the conditional handover configuration while in the sleep state.
Embodiment 6. The method of any previous Embodiment, wherein storing the conditional handover configuration comprises storing the conditional handover configuration as part of a user equipment, UE inactive Access Stratum, AS, context.
Embodiment 7. The method of any previous Embodiment, further comprising, in connection with transitioning to the sleep state:

stopping a timer associated with the conditional handover configuration; and

discarding a measurement associated with monitoring of the triggering condition associated with the conditional handover configuration.

Embodiment 8. The method of any previous Embodiment, further comprising:

starting a first timer upon entering the sleep state; and

deleting the stored conditional handover configuration upon expiration of the first timer.

Embodiment 9. The method of any previous Embodiment, wherein monitoring the triggering condition associated with the conditional handover configuration comprises performing a measurement and comparing the measurement to the trigger condition.
Embodiment 10. A wireless device (400) configured to operate in a communication network, the wireless device comprising:

processing circuitry (403); and

memory (405) coupled with the processing circuitry, wherein the memory includes instructions that when executed by the processing circuitry causes the wireless device to perform operations according to any of Embodiments 1-9.

Embodiment 11. A wireless device (400) configured to operate in a communication network, wherein the wireless device is adapted to perform according to any of Embodiments 19.
Embodiment 12. A computer program comprising program code to be executed by processing circuitry (403) of a wireless device (400) configured to operate in a communication network, whereby execution of the program code causes the wireless device (400) to perform operations according to any of Embodiments 1-9.
Embodiment 13. A computer program product comprising a non-transitory storage medium including program code to be executed by processing circuitry (403) of a wireless device (400) configured to operate in a communication network, whereby execution of the program code causes the wireless device (400) to perform operations according to any of Embodiments 1-9.
Embodiment 14. A method of operating a radio access network, RAN, node in a communication network, the method comprising:

transmitting (722) a command to a wireless device that is in a connected state and that has a stored conditional handover configuration associated with a target cell candidate to transition to a sleep state; and

storing (724) the conditional handover configuration.

Embodiment 15. The method of Embodiment 14, further comprising:

transmitting (726) a message toward a target node candidate that has the conditional handover configuration stored to suspend the conditional handover configuration for the wireless device.

Embodiment 16. The method of Embodiment 14 or 15, wherein the command instructs the wireless device to suspend to an inactive state or release to an idle state.
Embodiment 17. The method of Embodiment 14, wherein the sleep state comprises an RRC_INACTIVE state, an RRC_IDLE state, or an RRC_IDLE with suspended RRC connection state, and wherein the connected state comprises an RRC_CONNECTED state.
Embodiment 18. The method of any of Embodiments 14-17, wherein storing the conditional handover configuration comprises storing the conditional handover configuration in a user equipment, UE, inactive access stratum, AS, context.
Embodiment 19. A radio access network, RAN, node (500) configured to operate in a communication network, the wireless device comprising:

processing circuitry (503); and

memory (505) coupled with the processing circuitry, wherein the memory includes instructions that when executed by the processing circuitry causes the RAN node to perform operations according to any of Embodiments 14-18.

Embodiment 20. A radio access network, RAN, node (500) configured to operate in a communication network, wherein the RAN node is adapted to perform according to any of Embodiments 14-18.
Embodiment 21. A computer program comprising program code to be executed by processing circuitry (503) of a radio access network, RAN, node (500) configured to operate in a communication network, whereby execution of the program code causes the RAN node to perform operations according to any of Embodiments 14-18.
Embodiment 22. A computer program product comprising a non-transitory storage medium including program code to be executed by processing circuitry (503) of a radio access network, RAN, node (500) configured to operate in a communication network, whereby execution of the program code causes the RAN node to perform operations according to any of Embodiments 14-18.
Embodiment 23. A method of operating a radio access network, RAN, node in a communication network, the method comprising:

receiving (742) a first request from a source network node to configure conditional handover for a wireless device;

in response to the first request, transmitting (744) the conditional handover configuration to the source network node and reserving resources for conditional handover of the wireless device;

receiving (746) a second request from the source network node to suspend the conditional handover configuration for the wireless device; and

in response to the second request, suspending (748) the resources for conditional handover of the wireless device.

Embodiment 24. The method of Embodiment 23, wherein the first message comprises a conditional handover request or a handover request.
Embodiment 25. The method of Embodiment 24, further comprising transmitting a conditional handover request acknowledgement or handover request acknowledgement including the conditional handover configuration in response to the first request.
Embodiment 26. The method of any of Embodiments 23-25, wherein the resources for conditional handover of the wireless device comprise contention-free random access channel, RACH, resources.
Embodiment 27. The method of any of Embodiments 23-26, wherein the second request comprises a conditional handover suspend message or a handover suspend message.
Embodiment 28. A radio access network, RAN, node (500) configured to operate in a communication network, the wireless device comprising:

processing circuitry (503); and

memory (505) coupled with the processing circuitry, wherein the memory includes instructions that when executed by the processing circuitry causes the RAN node to perform operations according to any of Embodiments 23-27.

Embodiment 29. A radio access network, RAN, node (500) configured to operate in a communication network, wherein the RAN node is adapted to perform according to any of Embodiments 23-27.
Embodiment 30. A computer program comprising program code to be executed by processing circuitry (503) of a radio access network, RAN, node (500) configured to operate in a communication network, whereby execution of the program code causes the RAN node to perform operations according to any of Embodiments 23-27.
Embodiment 31. A computer program product comprising a non-transitory storage medium including program code to be executed by processing circuitry (503) of a radio access network, RAN, node (500) configured to operate in a communication network, whereby execution of the program code causes the RAN node to perform operations according to any of Embodiments 23-27.
Embodiment 32. A method of operating a wireless device in a communication network, the method comprising:

while in a sleep state, transmitting (902) a resume request to a network node to initiate transition from the sleep state to a connected state;

receiving (904) a resume message from the network node, wherein the resume message from the network node contains a command for handling a conditional handover configuration that was stored by the wireless device before transitioning to the sleep state;

transitioning (906) from the sleep state to the connected state; and

restoring, modifying or releasing (908) the conditional handover configuration in accordance with the command in the resume message.

Embodiment 33. The method of Embodiment 32, further comprising:

restoring (922) the conditional handover configuration; and

resuming (924) monitoring a triggering condition associated with the conditional handover configuration after transitioning to the connected state.

Embodiment 34. The method of Embodiment 32, wherein the command comprises new conditional handover configuration information and an indication to release the conditional handover configuration that was stored by the wireless device before transitioning to the sleep state, the method further comprising:

releasing (932) the conditional handover configuration that was stored by the wireless device before transitioning to the sleep state; and

activating (934) a new conditional handover configuration based on the new conditional handover configuration information in the command.

Embodiment 35. The method of Embodiment 32, wherein the resume message comprises new conditional handover configuration information, the method further comprising:

modifying (942) the conditional handover configuration that was stored by the wireless device before transitioning to the sleep state based on the new conditional handover configuration information; and

activating (944) the modified conditional handover configuration.

Embodiment 36. The method of any of Embodiments 32-35, wherein the resume request comprises an RRCResumeRequest or RRCConnectionResumeRequest message and wherein the resume message comprises an RRCResume message.
Embodiment 37. A wireless device (400) configured to operate in a communication network, the wireless device comprising:

processing circuitry (403); and

memory (405) coupled with the processing circuitry, wherein the memory includes instructions that when executed by the processing circuitry causes the wireless device to perform operations according to any of Embodiments 32-36.

Embodiment 38. A wireless device (400) configured to operate in a communication network, wherein the wireless device is adapted to perform according to any of Embodiments 32-36.
Embodiment 39. A computer program comprising program code to be executed by processing circuitry (403) of a wireless device (400) configured to operate in a communication network, whereby execution of the program code causes the wireless device (400) to perform operations according to any of Embodiments 32-36.
Embodiment 40. A computer program product comprising a non-transitory storage medium including program code to be executed by processing circuitry (403) of a wireless device (400) configured to operate in a communication network, whereby execution of the program code causes the wireless device (400) to perform operations according to any of Embodiments 31-34.
Embodiment 41. A method of operating a radio access network, RAN, node in a communication network, the method comprising:

receiving (1002) a resume request message from a wireless device that is in a sleep state;

retrieving (1004) a context associated with the wireless device;

determining (1006), based on the context, that conditional handover is supported by the wireless device;

determining (1008) to configure conditional handover at the wireless device for a target cell candidate with a condition related to a measurement event;

determining (1010) that the wireless device has a stored conditional handover configuration for the target cell candidate; and

transmitting (1012) a resume message to the wireless device.

Embodiment 42. The method of Embodiment 41, wherein the resume message includes a new conditional handover configuration for the wireless device with respect to the target cell candidate.
Embodiment 43. The method of Embodiment 41 or 42, further comprising:

generating the new conditional handover configuration based on the stored conditional handover configuration.

Embodiment 44. The method of Embodiment 43, further comprising:

generating the new conditional handover configuration using delta coding relative to the stored conditional handover configuration.

Embodiment 45. The method of any of Embodiments 41-44, wherein the resume request message comprises an RRCConnectionResumeRequest message or an RRCResumeRequest and wherein the resume message comprises an RRCResume message.
Embodiment 46. The method of any of Embodiments 41-45, wherein the context comprises a user equipment, UE, inactive access stratum, AS, context.
Embodiment 47. The method of any of Embodiments 41-46, further comprising:

initiating a conditional handover procedure for the target cell candidate with a target node candidate; and

receiving a response from the target node candidate, the response comprising an acknowledgement of resumption of a stored conditional handover configuration for the wireless device.

Embodiment 48. A radio access network, RAN, node (500) configured to operate in a communication network, the wireless device comprising:

processing circuitry (503); and

memory (505) coupled with the processing circuitry, wherein the memory includes instructions that when executed by the processing circuitry causes the RAN node to perform operations according to any of Embodiments 41-47.

Embodiment 49. A radio access network, RAN, node (500) configured to operate in a communication network, wherein the RAN node is adapted to perform according to any of Embodiments 41-47.
Embodiment 50. A computer program comprising program code to be executed by processing circuitry (503) of a radio access network, RAN, node (500) configured to operate in a communication network, whereby execution of the program code causes the RAN node to perform operations according to any of Embodiments 41-47.
Embodiment 51. A computer program product comprising a non-transitory storage medium including program code to be executed by processing circuitry (503) of a radio access network, RAN, node (500) configured to operate in a communication network, whereby execution of the program code causes the RAN node to perform operations according to any of Embodiments 41-47.
Embodiment 52. A method of operating a radio access network, RAN, node in a communication network, the method comprising:

receiving (1022) a request from a first network node to resume a suspended conditional handover configuration for a wireless device; and

resuming (1024) the suspended conditional handover configuration for the wireless device; and

transmitting (1026) a response to the first network node confirming resumption of the suspended conditional handover configuration for the wireless device.

Embodiment 53. The method of Embodiment 52, wherein the request comprises a conditional handover resume message or a handover resume message.
Embodiment 54. The method of Embodiment 52 or 53, wherein the response comprises a conditional handover resume acknowledgement or a handover resume acknowledgement.
Embodiment 55. The method of any of claims 52-54, wherein the response includes modifications to the conditional handover configuration for the wireless device.
Embodiment 56. The method of Embodiment 55, wherein the response specifies new random access channel, RACH, resources for the wireless device or a new radio network temporary identifier, RNTI, for the wireless device.
Embodiment 57. A radio access network, RAN, node (500) configured to operate in a communication network, the wireless device comprising:

processing circuitry (503); and

memory (505) coupled with the processing circuitry, wherein the memory includes instructions that when executed by the processing circuitry causes the RAN node to perform operations according to any of Embodiments 52-56.

Embodiment 58. A radio access network, RAN, node (500) configured to operate in a communication network, wherein the RAN node is adapted to perform according to any of Embodiments 52-56.
Embodiment 59. A computer program comprising program code to be executed by processing circuitry (503) of a radio access network, RAN, node (500) configured to operate in a communication network, whereby execution of the program code causes the RAN node to perform operations according to any of Embodiments 52-56.
Embodiment 60. A computer program product comprising a non-transitory storage medium including program code to be executed by processing circuitry (503) of a radio access network, RAN, node (500) configured to operate in a communication network, whereby execution of the program code causes the RAN node to perform operations according to any of Embodiments 52-56.

References are identified below.

### [1] 3GPP TS 38.331

### [2] 3GPP TS 36.331

### [3] 3GPP TS 38.420

Additional explanation is provided below.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a non-transitory computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A method of operating a wireless device in a communication network, the method comprising:
receiving a conditional handover configuration from a source network node, wherein the handover configuration is associated with a candidate target cell;
storing the conditional handover configuration;
monitoring a triggering condition associated with the conditional handover configuration during a connected state;
transitioning from the connected state to a sleep state while retaining the stored conditional handover configuration during the sleep state; and
suspending the monitoring of the triggering condition associated with the conditional handover configuration during the sleep state.

2. The method of claim 1, further comprising:
while in a sleep state, transmitting a resume request to a network node to initiate transition from the sleep state to a connected state;
receiving a resume message from the network node, wherein the resume message from the network node contains a command for handling a conditional handover configuration that was stored by the wireless device before transitioning to the sleep state;
transitioning from the sleep state to the connected state; and
restoring, modifying or releasing the conditional handover configuration in accordance with the command in the resume message.

3. The method of claim 2, further comprising:
responsive to the command indicating to restore the conditional handover configuration, restoring the conditional handover configuration; and
resuming monitoring the triggering condition associated with the conditional handover configuration.

4. The method of claim 2, wherein the command comprises new conditional handover configuration information and an indication to release the conditional handover configuration that was stored by the wireless device before transitioning to the sleep state, the method further comprising:
releasing the conditional handover configuration that was stored by the wireless device before transitioning to the sleep state; and
activating a new conditional handover configuration based on the new conditional handover configuration information in the command.

5. The method of claim 2, wherein the resume message comprises new conditional handover configuration information, the method further comprising:
modifying the conditional handover configuration that was stored by the wireless device before transitioning to the sleep state based on the new conditional handover configuration information; and
activating the modified conditional handover configuration.

6. The method of claim 1, wherein storing the conditional handover configuration comprises storing the conditional handover configuration as part of a equipment (UE) inactive Access Stratum (AS) context.

7. The method of claim 1, further comprising, in connection with transitioning to the sleep state:
stopping a timer associated with the conditional handover configuration; and
discarding a measurement associated with monitoring of the triggering condition associated with the conditional handover configuration.

8. The method of claim 1, further comprising:
starting a first timer upon entering the sleep state; and
deleting the stored conditional handover configuration upon expiration of the first timer.

9. The method of claim 1, wherein monitoring the triggering condition associated with the conditional handover configuration comprises performing a measurement and comparing the measurement to the trigger condition.

10. A wireless device configured to operate in a communication network, the wireless device comprising:
processing circuitry; and
memory coupled with the processing circuitry, wherein the memory includes instructions that when executed by the processing circuitry causes the wireless device to perform operations comprising:
receiving a conditional handover configuration from a source network node, wherein the handover configuration is associated with a candidate target cell;
storing the conditional handover configuration;
monitoring a triggering condition associated with the conditional handover configuration during a connected state;
transitioning from the connected state to a sleep state while retaining the stored conditional handover configuration during the sleep state; and
suspending the monitoring of the triggering condition associated with the conditional handover configuration during the sleep state.

11. The wireless device of claim 10, wherein the memory comprises further instructions that when executed by the processing circuitry causes the wireless device to perform further operations comprising:
while in a sleep state, transmitting a resume request to a network node to initiate transition from the sleep state to a connected state;
receiving a resume message from the network node, wherein the resume message from the network node contains a command for handling a conditional handover configuration that was stored by the wireless device before transitioning to the sleep state;
transitioning from the sleep state to the connected state; and
restoring, modifying or releasing the conditional handover configuration in accordance with the command in the resume message.

12. The wireless device of claim 11, wherein the memory comprises further instructions that when executed by the processing circuitry causes the wireless device to perform further operations comprising:
responsive to the command indicating to restore the conditional handover configuration, restoring the conditional handover configuration; and
resuming monitoring the triggering condition associated with the conditional handover configuration.

13. The wireless device of claim 11, wherein the command comprises new conditional handover configuration information and an indication to release the conditional handover configuration that was stored by the wireless device before transitioning to the sleep state, wherein the memory comprises further instructions that when executed by the processing circuitry causes the wireless device to perform further operations comprising:
releasing the conditional handover configuration that was stored by the wireless device before transitioning to the sleep state; and
activating a new conditional handover configuration based on the new conditional handover configuration information in the command.

14. The wireless device of claim 11, wherein the resume message comprises new conditional handover configuration information, wherein the memory comprises further instructions that when executed by the processing circuitry causes the wireless device to perform further operations comprising:
modifying the conditional handover configuration that was stored by the wireless device before transitioning to the sleep state based on the new conditional handover configuration information; and
activating the modified conditional handover configuration.

15. The wireless device of claim 10, wherein storing the conditional handover configuration comprises storing the conditional handover configuration as part of a user equipment (UE) inactive Access Stratum (AS) context.

16. The wireless device of claim 10, wherein the memory comprises further instructions that when executed by the processing circuitry causes the wireless device to perform further operations comprising, in connection with transitioning to the sleep state:
stopping a timer associated with the conditional handover configuration; and
discarding a measurement associated with monitoring of the triggering condition associated with the conditional handover configuration.

17. The wireless device of claim 10, wherein the memory comprises further instructions that when executed by the processing circuitry causes the wireless device to perform further operations comprising:
starting a first timer upon entering the sleep state; and
deleting the stored conditional handover configuration upon expiration of the first timer.

18-19. (canceled)

20. A method of operating a radio access network (RAN) node in a communication network, the method comprising:
receiving a first request from a source network node to configure conditional handover for a wireless device;
in response to the first request, transmitting the conditional handover configuration to the source network node and reserving resources for conditional handover of the wireless device;
receiving a second request from the source network node to suspend the conditional handover configuration for the wireless device; and
in response to the second request, suspending the resources for conditional handover of the wireless device.

21. The method of claim 20, wherein the resources for conditional handover of the wireless device comprise contention-free random access channel (RACH) resources.

22. The method of claim 21, the method comprising:
responsive to receiving the first request, transmitting a command to a wireless device that is in a connected state and that has a stored conditional handover configuration associated with a target cell candidate to transition to a sleep state;
storing the conditional handover configuration; and
transmitting a message toward a target node candidate that has the conditional handover configuration stored to suspend the conditional handover configuration for the wireless device.

23-40. (canceled)
